(19) United States
(12) Patent Application Publication
(10) Pub. No.: US 2015/0098033 A1
(43) Pub. Date: Apr. 9, 2015

(54) LIQUID CRYSTAL DISPLAY APPARATUS AND LIQUID CRYSTAL DRIVE METHOD

(71) Applicant: Sharp Kabushiki Kaisha, Osaka-shi, Osaka (JP)

(72) Inventors: Mitsuhiro Murata, Osaka-shi (JP); Yosuke Iwata, Osaka-shi (JP); Kohhei Tanaka, Osaka-shi (JP); Akihito Jinda, Osaka-shi (JP)

(21) Appl. No.: 14/383,583

(22) PCT Filed: Mar. 27, 2013
(86) PCT No.: PCT/JP2013/058938

§ 371 Date: Sep. 8, 2014

(30) Foreign Application Priority Data
Mar. 29, 2012 (JP) 2012-078183

(51) Int. Cl. G02F 1/1343

(52) U.S. Cl. CPC G02F 1/134309
USPC 349/33

(57) ABSTRACT

Provided are a liquid crystal display device and a liquid crystal driving method which can suitably switch between a driving operation with excellent visibility and a driving operation with an excellent response speed. The liquid crystal display device includes upper and lower substrates; liquid crystals sandwiched between the upper and lower substrates; and at least two pairs of electrodes disposed in the upper and lower substrates, the at least two pairs of electrodes including a first pair of electrodes consisting of electrodes disposed in one of the upper and lower substrates, and a second pair of electrodes consisting of electrodes disposed in the respective upper and lower substrates, the liquid crystal display device configured to drive the liquid crystals by generating a potential difference between each pair of the at least two pairs of electrodes, and to switch between a first driving operation of generating a potential difference only between the first pair of electrodes and a second driving operation of generating a potential difference between the first pair of electrodes and between the second pair of electrodes.

### TECHNICAL FIELD

The present invention relates to a liquid crystal display device and a liquid crystal driving method. More specifically, the present invention relates to a liquid crystal display device and a liquid crystal driving method which provide display by a driving operation of generating only a transverse electric field between electrodes or a driving operation of generating a vertical electric field and a transverse electric field between electrodes.

### BACKGROUND ART

A typical liquid crystal display device moves liquid crystal molecules in a liquid crystal layer sandwiched between a pair of substrates by generating an electric field between electrodes, and thus changes optical characteristics of the liquid crystal layer to allow its liquid crystal display panel to transmit or block light, thereby switching the ON state and the OFF state. Liquid crystal display devices having various structures have advantages such as low profile, light weight, and low power consumption, and have therefore been used in various applications by the above liquid crystal driving. For example, various driving methods have been developed and put into practical use for displays of devices such as personal computers, televisions, in-vehicle devices (e.g. automotive navigation systems), and personal digital assistants (e.g. smartphones, tablet terminals). In particular, more suitable driving methods for in-vehicle devices have been desired because in-vehicle devices such as a rear-view monitor, which gives a view of the rear side, have been widely used from the viewpoint of safety, and the number of vehicles equipped with a rear-view monitor by default is expected to increase in the coming years.

Patent Literature 1, for example, discloses a liquid crystal display device capable of providing a high response speed at low temperature, which includes a pair of substrates facing each other; liquid crystals enclosed between the substrates; a heater layer arranged on the opposed surface of at least one of the substrates and heated by electric currents; and a controller arranged on the opposed surface of at least one of the substrates, the controller including a temperature sensor and passing an electric current to the heater layer according to the temperature detected by the temperature sensor.

Patent Literature 2, for example, discloses a liquid crystal display device capable of preventing a decrease in the transmittance at low temperature. The liquid crystal display device includes a liquid crystal display panel, a temperature sensor for detecting the temperature of the liquid crystal display panel, and a controller for controlling the voltage applied to liquid crystals of the liquid crystal display panel. The controller controls the voltage applied to the liquid crystals to a voltage greater than the critical voltage during white display without black insertion driving in accordance with the temperature detected by the temperature sensor, and controls the voltage applied to the liquid crystals to a voltage lower than the critical voltage during white display with a limited value of the black insertion ratio by black insertion driving.

Various display methods (display modes) have been developed for liquid crystal display devices depending on the factors such as the liquid crystal characteristics, electrode arrangement, and substrate design. Display modes widely used in recent years are roughly classified into, for example, a vertical alignment (VA) mode in which liquid crystal molecules having a negative anisotropy of dielectric constant are aligned vertically to the substrate surfaces; an in-plane switching (IPS) mode in which liquid crystal molecules having a positive or negative anisotropy of dielectric constant are aligned horizontally to the substrate surfaces, and a transverse electric field is applied to the liquid crystal layer; and a fringe field switching (FFS) mode. For these display modes, some liquid crystal driving methods have been suggested.

Patent Literature 3, for example, discloses an FFS-mode liquid crystal display device which is a thin-film transistor liquid crystal display providing a high response speed and a wide viewing angle. The display device is provided with a first substrate including a first common electrode layer, a second substrate including both a pixel electrode layer and a second common electrode layer, liquid crystals disposed between the first and second substrates, and an instrument for generating an electric field between the first common electrode layer in the first substrate and both the pixel electrode layer and the second common electrode layer in the second substrate, so that a high response speed for a high input data transferring rate and provision of a wide-viewing angle for viewers are achieved.

Patent Literature 4, for example, discloses a liquid crystal device generating a transverse electric field using a plurality of electrodes. The liquid crystal device includes a pair of substrates arranged to face each other, and a liquid crystal layer that includes liquid crystals having a positive anisotropy of dielectric constant and is placed between the substrates. The substrates constituting the pair, namely a first substrate and a second substrate, are provided with respective electrodes facing each other with the liquid crystal layer in between. The electrodes generate a vertical electric field in the liquid crystal layer. The second substrate is also provided with electrodes for generating a transverse electric field in the liquid crystal layer.

### CITATION LIST

### Patent Literature

Patent Literature 1: JP 2007-309970 A

Patent Literature 2: JP 2007-140066 A

Patent Literature 3: JP 2006-523850 T

Patent Literature 4: JP 2002-365657 A

### SUMMARY OF THE INVENTION

### Technical Problem

The invention described in Patent Literature 1 described above is a liquid crystal display device that includes a transparent electrode (ITO) at part of a pixel opening, and passes an electric current to a PTC thermistor, so that the temperature is controlled by heating the pixels even at low temperature to provide a high response speed. Here, the transparent electrodes for controlling the temperature are driven by the TFTs, which decreases the aperture ratio and the transmittance, and increases the power consumption because of the current control.

Meanwhile, the invention described in Patent Literature 2 described above changes the driving to decrease the black insertion ratio (frame sections) when the temperature detected by the temperature sensor in an optically compensated bend (OCB) mode is zero or lower, so as to prevent a decrease in the transmittance even at low temperature. This invention, however, is designed to overcome the disadvantage of the OCB mode using a temperature sensor by changing the black insertion ratio to prevent orientation transition from bend alignment to splay alignment. Hence, this invention is irrelevant to the other liquid crystal modes.

In the case of in-vehicle devices described above such as a rear-view monitor that allows the driver to see the rear side, fatal accidents involving a child or old person could happen if the safe visibility (which enables stable view of images including moving images even at low temperature) is low at the start of operation where the temperature of devices is low, especially in cold regions. These factors, together with the recent increase in the number of vehicles equipped with a rear-view monitor by default, have led to a strong desire for sufficient safe visibility and other excellent display characteristics such as transmittance.

An FFS-mode liquid crystal display device having a vertical alignment three-layered electrode structure achieves a high response speed by rotating the liquid crystal molecules by an electric field in both rising and falling. The rising (where the display state changes from a dark state (black display) to a bright state (white display)) utilizes a fringe electric field (FFS driving) generated between an upper slit electrode and a lower planar electrode of the lower substrate. The falling (where the display state changes from a bright state (white display) to a dark state (black display)) utilizes a vertical electric field generated by a potential difference between the substrates.

If, however, the liquid crystal display device to which such a fringe electric field is applied by slit electrodes contains vertically aligned liquid crystal molecules as described in Patent Literature 3, only the liquid crystal molecules near the slit electrode ends are rotated (cf. FIG. 60). Hence, the transmittance thereof is insufficient.

FIG. 58 is a schematic cross-sectional view illustrating a liquid crystal display panel having a conventional FFS-mode electrode structure on the lower substrate in the presence of a fringe electric field. FIG. 59 is a schematic plan view illustrating the liquid crystal display panel illustrated in FIG. 58. FIG. 60 is a schematic plan view illustrating the liquid crystal display panel illustrated in FIG. 58. FIG. 60 shows simulation results of director distribution, electric field distribution, and transmittance distribution in the liquid crystal display panel illustrated in FIG. 58. FIG. 58 illustrates the structure of the liquid crystal display panel. A certain voltage is applied to slit electrodes (5 V in the figure; for example, the potential difference between each slit electrode and a lower electrode (counter electrode) 713 is at least the threshold value; the “threshold value” herein means a voltage value that generates an electric field causing optical changes of the liquid crystal layer and changes in the display state of the liquid crystal display device). The lower electrode (counter electrode) 713 and a counter electrode 723 are disposed on the substrate having the slit electrodes thereon and its counter substrate, respectively. The lower electrode 713 and the counter electrode 723 are each set to 0 V. FIG. 60 shows the simulation results in rising relating to voltage distribution, director D distribution, and transmittance distribution (solid line).

Patent Literature 4 teaches a liquid crystal display device having a three-layered electrode structure which employs comb driving to increase the response speed. Patent Literature 4, however, merely substantially mentions a liquid crystal device in the twisted nematic (TN) display mode, and does not show any liquid crystal display device in a vertical alignment mode which is advantageous to achieve characteristics such as a wide viewing angle and a high contrast. Patent Literature 4 does not disclose an increase in the transmittance or the relation between an electrode structure and a transmittance either.

The present invention has been made in view of the above current state of the art. The object of the present invention is to provide a liquid crystal display device and a liquid crystal driving method which can suitably switch between a driving operation providing excellent visibility and a driving operation providing an excellent response speed.

### Solution to Problem

The present inventors have studied a vertical alignment liquid crystal display device and a liquid crystal driving method which can suitably switch between a driving operation providing excellent visibility and a driving operation providing excellent response speed. The inventors have first focused on a liquid crystal display device which generates a potential difference between at least two pairs of electrodes for controlling the alignment of liquid crystal molecules by electric fields in both rising and falling. As a result, the present inventors have found a driving method achieving a high response speed by rotating liquid crystal molecules by electric fields in both rising and falling [a driving method including switching the ON and OFF states of the electric field between two pairs of electrodes (switching from an electric field applied state to another electric field applied state)]. In this method, the upper electrode of the lower substrate is designed to work under comb driving such that in rising, a transverse electric field is generated by a potential difference between the comb-shaped electrodes, and a vertical electric field is generated by a potential difference between the substrates together with a transverse electric field, and in falling, a vertical electric field is generated by a potential difference between the substrates. The present inventors have also found that this driving method has a disadvantage that the transmittance is lower than that in the TBA mode that utilizes the transverse electric field only. That is, since the transmittance decreases while the vertical electric field required for a high response speed is generated, the transmittance at ordinary temperature decreases compared to that in the TBA mode in which a transverse electric field only is used. Then, the present inventors have further made studies on the driving method, and have found that when visibility is required, the transmittance can be increased by generating a potential difference only between a pair of electrodes (first pair of electrodes) consisting of the electrodes disposed on one of the upper and lower substrates. When a high response speed is required at low temperature, electric fields are formed by a driving operation of generating a potential difference between a pair of electrodes (second pair of electrodes) consisting of electrodes disposed separately in the upper and lower substrates and a driving operation of generating a potential difference between the first pair of electrodes. Thereby, the liquid crystal molecules are rotated by these electric fields, so that the liquid crystal display device can achieve a high response speed. If the liquid crystal display device includes a temperature sensor, for example, and switches the driving methods according to the temperature measured by the temperature sensor, then the liquid crystal display device can utilize a suitable mode from time to time. Thereby, the above disadvantages have been overcome, and thus the present invention has been completed.

In a liquid crystal display device having a vertical alignment three-layered electrode structure of the present invention, the upper electrode of the lower substrate is designed to provide comb driving such that in rising, a transverse electric field is generated by a potential difference at least between the comb-shaped electrodes, and in falling, a vertical electric field is generated by a potential difference between the substrates. Thereby, the liquid crystal display device utilizes a driving method that achieves a high response speed by rotating liquid crystal molecules by electric fields in both rising and falling, and also achieves a high transmittance by a transverse electric field under the comb driving.

For the present invention, temperature sensors can be used in the same way as for the inventions described in Patent Literatures 1 and 2. The present invention, however, is different from the inventions described in the cited documents in that the driving operation is switched between a first driving operation of generating a potential difference only between a pair of electrodes (first pair of electrodes) consisting of the electrodes disposed on one of the upper and lower substrates and a second driving operation of generating a potential difference between another pair of substrates (second pair of substrates) consisting of the electrodes disposed separately in the upper and lower substrates and between the first pair of electrodes. For example, the TBA mode (liquid crystal mode for a high response speed) is used at from ordinary temperature to a temperature not lower than −10° C., and the mode is switched to an ultra-high speed liquid crystal mode in which a vertical alignment is used together at a temperature of −10° C. or lower. The liquid crystal display device of the present invention is particularly designed to achieve the safety required for instrument panels and rear-view monitors and a high response speed at low temperature, and is therefore suitably applicable to an in-vehicle display device.

The present invention achieves a high transmittance and good visibility at ordinary temperature, and provides an ultra-high response speed at low temperature at the start of operation by, for example, switching the mode to a liquid crystal display mode utilizing both the vertical and transverse electric fields. That is, at low temperature where the response speed is a particularly notable disadvantage, the present invention overcomes the disadvantage and achieves a sufficient transmittance and, at ordinary temperature, the present invention achieves an excellent transmittance.

As described above, the present invention is different from the inventions described in the above Patent Literature documents in that the present invention switches the liquid crystal modes (driving methods) using a temperature sensor.

That is, one aspect of the present invention is a liquid crystal display device including: upper and lower substrates; liquid crystals sandwiched between the upper and lower substrates; and at least two pairs of electrodes disposed in the upper and lower substrates, the at least two pairs of electrodes comprising a first pair of electrodes consisting of electrodes disposed in one of the upper and lower substrates, and a second pair of electrodes consisting of electrodes disposed in the respective upper and lower substrates, the liquid crystal display device configured to drive the liquid crystals by generating a potential difference between each pair of the at least two pairs of electrodes, and to switch between a first driving operation of generating a potential difference only between the first pair of electrodes and a second driving operation of generating a potential difference between the first pair of electrodes and between the second pair of electrodes.

The first pair of electrodes and the second pair of electrodes may share the same electrode(s). The liquid crystal display device of the present invention may further include other pair(s) of electrodes different from the first pair of electrodes and the second pair of electrodes.

Generating a potential difference between the first pair of electrodes means generating a potential difference between at least the first pair of electrodes, so that the alignment of the liquid crystals is controlled by the electric field between the first pair of electrodes. Generating a potential difference between the second pair of electrodes means generating a potential difference between at least the second pair of electrodes, so that the alignment of the liquid crystals is controlled by the electric field between the second pair of electrodes.

The driving operation of generating a potential difference between the first pair of electrodes and the second pair of electrodes does not mean keeping generating a potential difference between the first pair of electrodes and the second pair of electrodes during the driving operation. The driving operation may be, for example in a driving method including sub-frames each being a driving cycle from changing the state of the liquid crystals to returning the liquid crystals to the initial state, generating a potential difference between the first pair of electrodes and generating a potential difference also between the second pair of electrodes in the sub-frame. Also, the operation may generate a potential difference between the first pair of electrodes and a potential difference between the second pair of electrodes simultaneously.

Preferably, the liquid crystal display device further includes a temperature sensor, wherein the liquid crystal display device implements the first driving operation when the temperature of the liquid crystal display device measured by the temperature sensor is a certain switching temperature or higher, while the liquid crystal display device implements the second driving operation when the temperature of the liquid crystal display device is lower than the switching temperature.

The temperature of the liquid crystal display device may be the temperature of any component or in any space as long as it is a temperature of the device. Still, the temperature is preferably the surface temperature of the liquid crystal panel (on the viewer side), for example. In other words, it is preferably the glass surface temperature on the side opposite to the blacklight surface. The same applies to the temperature of the later-described liquid crystal display devices.

The switching temperature is not particularly limited, and may be measured in 1° C. units, 0.1° C. units, or in any other units.

The switching temperature is preferably −10° C. or lower. The switching temperature is also preferably −18° C. or higher.

The first pair of electrodes is preferably a pair of comb-shaped electrodes, and is more preferably disposed such that the two comb-shaped electrodes face each other in a plan view of the main faces of the substrates. These comb-shaped electrodes enable suitable generation of a transverse electric field between the comb-shaped electrodes, and therefore contribute to excellent response characteristics and excellent transmittance in rising when the liquid crystal layer includes liquid crystal molecules having a positive anisotropy of dielectric constant. The pair of comb-shaped electrodes preferably has teeth that are aligned along each other in a plan view of the main faces of the substrates. In particular, the pair of comb-shaped electrodes preferably has teeth that are substantially parallel to each other. In other words, each of the pair of comb-shaped electrodes preferably has slits that are substantially parallel to each other. Although FIG. 1 and FIG. 13, for example, schematically illustrate a pair of comb-shaped electrodes each having one tooth, a comb-shaped electrode typically has at least two teeth.

The second pair of electrodes can consist of, for example, the comb-shaped electrodes and/or a planar electrode formed under the comb-shaped electrodes with an insulating layer disposed in between; and a planar electrode formed on the counter substrate. The electrodes of the second pair each preferably have a planar shape. In other words, the counter electrodes disposed on the respective upper and lower substrates each preferably have a planar shape. With this structure, a vertical electric field can be more suitably generated. The planar electrode as used herein includes an electrode whose portions in multiple pixels are electrically connected. Preferable examples of such a planar electrode include an electrode whose portions in all of the pixels are electrically connected, and an electrode whose portions in a pixel line are electrically connected. What is meant by the “planar shape” may be any shape considered to be a planar shape in the technical field of the present invention, and the shape may include alignment control objects such as ribs or slits partly in the region, or may include alignment control objects in the respective central portions of the pixels in a plan view of the main faces of the substrates. As to the counter electrode in the upper substrate, it is suitable that the counter electrode includes substantially no alignment control objects. The counter electrode (lower electrode) in the lower substrate may substantially include alignment control objects, or may include substantially no alignment control objects. That is, the lower electrode may or may not include openings. If, for example, the counter electrode in the upper substrate is a planar electrode without openings and the counter electrode (for example, lower electrode) in the lower substrate is a planar electrode, the counter electrode in the lower substrate may or may not include openings. Both structures are preferred embodiments of the present invention.

To suitably generate a transverse electric field and a vertical electric field, a structure is particularly preferred in which the liquid crystal layer side electrodes (upper electrodes) are the first pair of electrodes, and an electrode (lower electrode) on the side opposite to the liquid crystal layer side is one of the second pair of electrodes. Preferably, the one of the second pair of electrodes is separated from the first pair of electrodes by an insulating layer. For example, the one of the second pair of electrodes can be disposed under the first pair of electrodes (on the side of the second substrate opposite to the liquid crystal layer side) with an insulating layer disposed therebetween. Furthermore, the one of the second pair of electrodes (lower electrode) may be independently provided to the pixels, but in one preferred embodiment of the present invention, the individual electrodes are electrically connected to each other in one pixel line. When one of the first pair of electrodes is connected to the one of the second pair of electrodes disposed thereunder and the one of the second pair of electrodes includes portions in one line of pixels electrically connected to each other, the one of the first pair of electrodes include portions electrically connected to each other in the one line of pixels. This structure is also one preferred embodiment of the present invention. The one of the second pair of electrodes preferably has a planar shape at at least a part overlapping the other of the second pair of electrodes in a plan view of the main faces of the substrates.

The preferred embodiment of the liquid crystal display device of the present invention utilizes a preferred embodiment of the liquid crystal driving method of the present invention described below.

Another aspect of the present invention is a liquid crystal driving method for driving liquid crystals sandwiched between upper and lower substrates by generating a potential difference between each pair of at least two pairs of electrodes disposed in upper and lower substrates, the at least two pairs of electrodes including a first pair of electrodes consisting of electrodes disposed in one of the upper and lower substrates, and a second pair of electrodes consisting of electrodes disposed in the respective upper and lower substrates, the liquid crystal driving method including switching between a first driving operation of generating a potential difference only between the first pair of electrodes and a second driving operation of generating a potential difference between the first pair of electrodes and between the second pair of electrodes.

Preferred embodiments of the liquid crystal driving method of the present invention are the same as the preferred embodiments of the liquid crystal display device of the present invention described above.

For example, preferably, the liquid crystal driving method implements the first driving operation when the temperature of the liquid crystal display device measured by the temperature sensor is a certain switching temperature or higher, while the method implements the second driving operation when the temperature of the liquid crystal display device is lower than the switching temperature. The switching temperature is preferably −10° C. or lower. The switching temperature is also preferably −18° C. or higher. The first pair of electrodes is preferably a pair of comb-shaped electrodes. The electrodes constituting the second pair each preferably have a planar shape. Furthermore, one of the second pair of electrodes is preferably separated from the first pair of electrodes by an insulating layer.

The liquid crystal driving method is a method using active matrix driving. The active matrix driving preferably performs a driving operation by driving liquid crystals using bus lines for thin-film transistors, and inverting the electric potential of the electrode in the Nth bus line and the electric potential of the electrode in the (N+1)st bus line. Inverting the potential change between the electrode in the Nth bus line and the electrode in the (N+1)st bus line means causing a positive potential change and a negative potential change to a potential. Preferably, the absolute values of the potential changes are substantially the same.

The second pair of electrodes can usually provide a potential difference between the substrates. Thereby, a vertical electric field is generated by a potential difference between the substrates in falling (the liquid crystal layer includes liquid crystal molecules having a positive anisotropy of dielectric constant) and in rising (the liquid crystal layer includes liquid crystal molecules having a negative anisotropy of dielectric constant), so that the electric field rotates the liquid crystal molecules to achieve a high-speed response. For example, in falling, the electric field generated between the upper and lower substrates rotates the liquid crystal molecules in the liquid crystal layer into the direction vertical to the main faces of the substrates, whereby a high-speed response is achieved. As described above, it is particularly preferred that the first pair of electrodes is a pair of comb-shaped electrodes disposed on one of the upper and lower substrates, and the second pair of electrodes are counter electrodes disposed on the respective upper and lower substrates.

The pair of comb-shaped electrodes may be disposed in the same layer or in different layers if the effect of the present invention can be achieved. Still, the pair of comb-shaped electrodes is preferably disposed in the same layer. What is meant by disposing the pair of comb-shaped electrodes in the same layer is that each of the comb-shaped electrodes is in contact with a common component (e.g. insulating layer, liquid crystal layer) on the liquid crystal layer side and/or the side opposite to the liquid crystal layer side.

The liquid crystals preferably include liquid crystal molecules aligned in the vertical direction to the main faces of the substrates at a voltage lower than the threshold voltage. Also, what is meant by being aligned in the vertical direction to the main faces of the substrates is that the liquid crystals are aligned in the direction considered to be vertical to the main faces of the substrates in the technical field of the present invention, and the state includes substantial vertical alignment. Such vertically aligned liquid crystals are advantageous to obtain characteristics such as a wide viewing angle and a high contrast, and thus the applications thereof have been expanding. The threshold voltage means a voltage that provides a transmittance of 5% when the transmittance in the bright state is set to 100%, for example.

The electrodes of the first pair are usually capable of creating a potential difference that is equal to the threshold voltage or higher. What is meant by creating a potential difference that is equal to the threshold voltage or higher is performing the driving operation of creating a potential difference that is equal to the threshold voltage or higher, which enables suitable control of the electric field generated in the liquid crystal layer. The preferred upper limit for the potential difference is, for example, 20 V. Such a potential difference can be created by a structure of, for example, driving one of the first pair of electrodes by a TFT while driving the other electrode by another TFT or connecting the other electrode to the electrode under the other electrode, so as to enable the first pair of electrodes to create a potential difference. If the first pair of electrodes is a pair of comb-shaped electrodes, the width of each tooth of the pair of comb-shaped electrodes is, for example, 2 μm or greater. Furthermore, the width between teeth (also referred to as a space herein) is preferably 2 μm to 7 μm, for example.

The same pixel line is, for example in the case of active matrix driving, a line of pixels disposed along a gate bus line or a source bus line under the active matrix driving in a plan view of the main faces of the substrates. In this way, if at least one of the second pair of electrodes includes portions electrically connected to each other in the same pixel line, voltages can be applied such that the potential change in the pixels along an even gate bus line and the potential change in the pixels along an odd gate bus line are inverted. As a result, a suitable vertical electric field is generated, and thus a high-speed response can be achieved.

The liquid crystals preferably include molecules aligned in the horizontal direction to the main faces of the substrates when the potential difference of the first pair of electrodes is equal to the threshold voltage or higher. Here, being aligned in the horizontal direction may be any alignment state considered to be horizontal in the technical field of the present invention. With such alignment, the response speed can be increased while the transmittance is increased when the liquid crystals include liquid crystal molecules having a positive anisotropy of dielectric constant (positive liquid crystal molecules). It is suitable that the liquid crystals substantially consist of liquid crystal molecules aligned in the horizontal direction to the main faces of the substrates when the potential difference is equal to the threshold voltage or higher.

The liquid crystals preferably have a positive anisotropy of dielectric constant. Liquid crystals having a positive anisotropy of dielectric constant (positive liquid crystal molecules) are aligned in a certain direction when an electric field is generated. Hence, the alignment thereof can be easily controlled and the response speed can be further increased. The liquid crystal layer also preferably includes liquid crystal molecules having a negative anisotropy of dielectric constant (negative liquid crystal molecules). Thereby, the transmittance can be further increased. That is, from the viewpoint of increasing the response speed, it is suitable that the liquid crystals substantially consist of liquid crystal molecules having a positive anisotropy of dielectric constant. From the viewpoint of the transmittance, it is suitable that the liquid crystals substantially consist of liquid crystal molecules having a negative anisotropy of dielectric constant.

At least one of the upper and lower substrates usually includes an alignment film on the liquid crystal side. The alignment film is preferably a vertical alignment film. Examples of the alignment film include alignment films formed from an organic material or an inorganic material, photoalignment films formed from a photoactive material, and alignment films on which an alignment treatment has been performed by rubbing, for example. The alignment film may not be subjected to the alignment treatment by rubbing. Alignment films which do not require alignment treatment, such as alignment films formed from an organic material or an inorganic material and photoalignment films, facilitate the process, so as to reduce the cost and also increase the reliability and the yield. If an alignment film is rubbed, the rubbing may cause disadvantages such as liquid crystal contamination due to impurities from rubbing cloth, dot defects due to contaminants, and uneven display due to uneven rubbing in each liquid crystal panel. The present invention can eliminate these disadvantages. At least one of the upper and lower substrates preferably includes a polarizing plate on the side opposite to the liquid crystal layer. The polarizing plate is preferably a circularly polarizing plate. This makes it possible to further increase the transmittance. The polarizing plate may also preferably be a linearly polarizing plate. This makes it possible to give excellent viewing angle characteristics.

The driving method of the present invention may or may not include a mode (initialization process) of performing, after generation of a vertical electric field, the driving operation of generating substantially no potential difference between any of the electrodes of the first and second pair of electrodes. The initialization process enables suitable control of alignment of liquid crystals near the edge of at least one pair of electrodes of the first and second pairs of electrodes (e.g. the pair of comb-shaped electrodes), and a more sufficient decrease in the transmittance in black display.

In a transverse electric field, typically, a potential difference is generated between at least the first pair of electrodes (e.g. between the pair of comb-shaped electrodes disposed on one of the upper and lower substrates).

Here, the potential changes can be inverted by applying a voltage to the commonly connected lower electrode portions (one of the second pair of electrodes) corresponding to even-numbered or odd-numbered lines. The electric potential of an electrode maintained at a certain voltage may be defined as a middle electric potential. Assuming that this electric potential of an electrode maintained at the certain voltage is 0 V, the polarity of the voltage applied to the lower electrodes corresponding to the respective bus lines is considered to be inverted.

The upper and lower substrates of the liquid crystal display device of the present invention usually constitute a pair of substrates between which the liquid crystal layer is sandwiched. They are each formed by forming lines, electrodes, color filters, or the like components on an insulation substrate (e.g. glass, resin) which is a base material. In the liquid crystal driving method of the present invention, a dielectric layer is preferably provided on at least one of the upper and lower substrates.

It is preferred that at least one of the first pair of electrodes is a pixel electrode and that the substrate including the first pair of electrodes is an active matrix substrate. The liquid crystal driving method of the present invention is applicable to a liquid crystal display device of any of the transmissive type, reflection type, and transflective type.

The liquid crystal display device and the liquid crystal driving method of the present invention are preferably applied to displays of devices such as personal computers, televisions, in-vehicle devices (e.g. automotive navigation systems), and personal digital assistants (e.g. mobile phones). Particularly preferably, the liquid crystal display device and the liquid crystal driving method are applied to devices used at low-temperature conditions, such as in-vehicle devices including automotive navigation systems.

The configurations of the liquid crystal display device and the liquid crystal driving method of the present invention are not especially limited by other components as long as they essentially include such components, and other configurations usually used in liquid crystal display devices and liquid crystal driving methods may appropriately be applied.

The above structures may be appropriately combined as long as the combination does not go beyond the scope of the present invention.

### Effect of the Invention

The liquid crystal display device and liquid crystal driving method of the present invention drive liquid crystals using the first pair of electrodes and the second pair of electrodes, enabling switching between the driving operation with excellent visibility and the driving operation with an excellent response speed.

### BRIEF DESCRIPTION OF DRAWINGS

FIG. 1 is a schematic cross-sectional view of a liquid crystal display device in the presence of a transverse electric field under the first driving operation of Embodiment 1.

FIG. 2 is a schematic cross-sectional view of a liquid crystal display device in the presence of a vertical electric field and a transverse electric field under the second driving operation of Embodiment 1.

FIG. 3 is a schematic cross-sectional view of a liquid crystal display device in the presence of a vertical electric field under the second driving operation of Embodiment 1.

FIG. 4 is a schematic cross-sectional view of a liquid crystal display device at ordinary temperature (in the presence of a transverse electric field) under the first driving operation of Embodiment 1.

FIG. 5 is a schematic cross-sectional view of a liquid crystal display device at low temperature (in the presence of a vertical electric field and a transverse electric field) under the second driving operation of Embodiment 1.

FIG. 6 is a schematic cross-sectional view of a liquid crystal display device at low temperature (in the presence of a vertical electric field) under the second driving operation of Embodiment 1.

FIG. 7 is a graph showing a standardized transmittance in response to the applied voltage in the presence of a transverse electric field under the first driving operation and in the presence of a vertical electric field and a transverse electric field under the second driving operation.

FIG. 8 is a graph showing the gray-scale response at 25° C. under the driving with a transverse electric field.

FIG. 9 is a graph showing the temperature characteristics of response from a gray-scale value of 0 to a gray-scale value of 64 under the driving with a transverse electric field.

FIG. 10 is a graph showing a gray-scale response at −30° C. under low-temperature driving.

FIG. 11 shows simulation results relating to the liquid crystal display panel illustrated in FIG. 4.

FIG. 12 is a schematic cross-sectional view of a liquid crystal display panel of Embodiment 2.

FIG. 13 is a schematic plan view of a sub-pixel in the liquid crystal display panel of Embodiment 2.

FIG. 14 is a view of a sub-pixel equivalent circuit of the liquid crystal display panel of Embodiment 2.

FIG. 15 is a view showing a potential change of electrodes in the liquid crystal display panel of Embodiment 2.

FIG. 16 is a schematic cross-sectional view illustrating the electrodes in the Nth line in the liquid crystal display panel of Embodiment 2 in the presence of a transverse electric field.

FIG. 17 is a schematic cross-sectional view illustrating the electrodes in the Nth line in the liquid crystal display panel of Embodiment 2 in the presence of a vertical electric field.

FIG. 18 is a schematic cross-sectional view illustrating the electrodes in the Nth line in the liquid crystal display panel of Embodiment 2 in the initialization process after generation of a vertical electric field.

FIG. 19 is a schematic cross-sectional view illustrating the electrodes in the (N+1)st line in the liquid crystal display panel of Embodiment 2 in the presence of a transverse electric field.

FIG. 20 is a schematic cross-sectional view illustrating the electrodes in the (N+1)st line in the liquid crystal display panel of Embodiment 2 in the presence of a vertical electric field.

FIG. 21 is a schematic cross-sectional view illustrating the electrodes in the (N+1)st line in the liquid crystal display panel of Embodiment 2 in the initialization process after generation of a vertical electric field.

FIG. 22 is a schematic cross-sectional view of a liquid crystal display panel of Embodiment 3.

FIG. 23 is a schematic plan view of a sub-pixel in the liquid crystal display panel of Embodiment 3.

FIG. 24 is a view of a sub-pixel equivalent circuit of the liquid crystal display panel of Embodiment 3.

FIG. 25 is a view showing a potential change of electrodes in the liquid crystal display panel of Embodiment 3.

FIG. 26 is a schematic cross-sectional view illustrating the electrodes in the Nth line in the liquid crystal display panel of Embodiment 3 in the presence of a transverse electric field.

FIG. 27 is a schematic cross-sectional view illustrating the electrodes in the Nth line in the liquid crystal display panel of Embodiment 3 in the initialization process after generation of a transverse electric field.

FIG. 28 is a schematic cross-sectional view illustrating the electrodes in the Nth line in the liquid crystal display panel of Embodiment 3 in the presence of a vertical electric field.

FIG. 29 is a schematic cross-sectional view illustrating the electrodes along the Nth line in the liquid crystal display panel of Embodiment 3 in the initialization process after generation of a vertical electric field.

FIG. 30 is a schematic cross-sectional view illustrating the electrodes along the (N+1)st line in the liquid crystal display panel of Embodiment 3 in the presence of a transverse electric field.

FIG. 31 is a schematic cross-sectional view illustrating the electrodes along the (N+1)st line in the liquid crystal display panel of Embodiment 3 in the initialization process after generation of a transverse electric field.

FIG. 32 is a schematic cross-sectional view illustrating the electrodes along the (N+1)st line in the liquid crystal display panel of Embodiment 3 in the presence of a vertical electric field.

FIG. 33 is a schematic cross-sectional view illustrating the electrodes along the (N+1)st line in the liquid crystal display panel of Embodiment 3 in the initialization process after generation of a vertical electric field.

FIG. 34 is a schematic cross-sectional view of a liquid crystal display panel of an alternative embodiment of Embodiment 3.

FIG. 35 is a schematic plan view of a sub-pixel in the liquid crystal display panel of the alternative embodiment of Embodiment 3.

FIG. 36 is a view of a sub-pixel equivalent circuit of the liquid crystal display panel of the alternative embodiment of Embodiment 3.

FIG. 37 is a view showing a potential change of electrodes in the liquid crystal display panel of the alternative embodiment of Embodiment 3.

FIG. 38 is a schematic cross-sectional view illustrating the electrodes in the Nth line in the liquid crystal display panel of the alternative embodiment of Embodiment 3 in the presence of a transverse electric field.

FIG. 39 is a schematic cross-sectional view illustrating the electrodes in the Nth line in the liquid crystal display panel of the alternative embodiment of Embodiment 3 in the presence of a vertical electric field.

FIG. 40 is a schematic cross-sectional view illustrating the electrodes in the Nth line in the liquid crystal display panel of the alternative embodiment of Embodiment 3 in the initialization process after generation of a vertical electric field.

FIG. 41 is a schematic cross-sectional view illustrating the electrodes along the (N+1)st line in the liquid crystal display panel of the alternative embodiment of Embodiment 3 in the presence of a transverse electric field.

FIG. 42 is a schematic cross-sectional view illustrating the electrodes along the (N+1)st line in the liquid crystal display panel of the alternative embodiment of Embodiment 3 in the presence of a vertical electric field.

FIG. 43 is a schematic cross-sectional view illustrating the electrodes along the (N+1)st line in the liquid crystal display panel of the alternative embodiment of Embodiment 3 in the initialization process after generation of a vertical electric field.

FIG. 44 is a schematic cross-sectional view of a liquid crystal display panel of Embodiment 4.

FIG. 45 is a graph showing simulated response waveforms relative to the presence or absence of a dielectric layer on the surface of a counter electrode.

FIG. 46 is a view of a sub-pixel equivalent circuit of the liquid crystal display panel of Embodiment 4.

FIG. 47 is a schematic cross-sectional view illustrating the electrodes in the Nth line in the liquid crystal display panel of Embodiment 4 in the presence of a transverse electric field.

FIG. 48 is a schematic cross-sectional view illustrating the electrodes in the Nth line in the liquid crystal display panel of Embodiment 4 in the presence of a vertical electric field.

FIG. 49 is a schematic cross-sectional view illustrating the electrodes in the Nth line in the liquid crystal display panel of Embodiment 4 in the initialization process after generation of a vertical electric field.

FIG. 50 is a schematic cross-sectional view of a liquid crystal display panel of Embodiment 5.

FIG. 51 is a view of a sub-pixel equivalent circuit of the liquid crystal display panel of Embodiment 5.

FIG. 52 is a schematic cross-sectional view illustrating the electrodes in the Nth line in the liquid crystal display panel of Embodiment 5 in the presence of a vertical electric field and a transverse electric field.

FIG. 53 is a schematic cross-sectional view illustrating the electrodes in the Nth line in the liquid crystal display panel of Embodiment 5 in the presence of a vertical electric field.

FIG. 54 is a schematic cross-sectional view illustrating the electrodes in the Nth line in the liquid crystal display panel of Embodiment 5 in the initialization process after generation of a vertical electric field.

FIG. 55 is a schematic plan view of one form of a thin-film transistor (Si semiconductor layer) used for pixel electrodes of a liquid crystal display panel of the present invention.

FIG. 56 is a schematic cross-sectional view of a liquid crystal display device at ordinary temperature under the conventional driving operation.

FIG. 57 is a schematic cross-sectional view of the liquid crystal display device at low temperature under the conventional driving operation.

FIG. 58 is a schematic cross-sectional view of a liquid crystal display panel in the presence of a fringe electric field.

FIG. 59 is a schematic plan view of the liquid crystal display panel illustrated in FIG. 58.

FIG. 60 shows simulation results relating to the liquid crystal display panel illustrated in FIG. 58.

FIG. 61 illustrates a thin film transistor (oxide semiconductor layer) used for the pixel electrodes of a liquid crystal display panel of the present invention.

### DESCRIPTION OF EMBODIMENTS

The present invention will be described in more detail below with reference to the drawings based on embodiments which, however, are not intended to limit the scope of the present invention. A “pixel” herein may be a sub-pixel unless otherwise specified. A “frame” means the time required to provide an image with all the pixels (e.g. RGB pixels). A “sub-frame” means the time required to provide an image of one color in sequential display of the colors in one frame under the field sequential (time division) driving using some or all of the sub-pixels. A “sub-frame” as used herein refers to the period of time for the provision of the image. The planar electrode may include dot ribs and/or slits, for example, as long as it is regarded as a planar electrode in the technical field of the present invention. Of the pair of substrates between which the liquid crystal layer is sandwiched, the display side substrate is also referred to as an upper substrate, and the substrate on the side opposite to the display side is also referred to as a lower substrate. Of the electrodes disposed on the substrates, the electrode on the display side is also referred to as an upper electrode, and the electrode on the side opposite to the display side is also referred to as a lower electrode. Since a circuit board (second substrate) in each of the present embodiments has thin-film transistors (TFTs), the circuit board is also referred to as a TFT substrate or an array substrate. In the second driving operation of the present embodiments, a voltage is applied to at least one of the pair of comb-shaped electrodes (pixel electrodes) by turning the TFTs to the ON state in both rising (at least transverse electric field is generated) and falling (vertical electric field is generated).

In each embodiment, the components or parts having the same function are given the same reference number. Also in the drawings, the symbol (i) refers to the electric potential of one of the comb-shaped electrodes constituting the upper layer of the lower substrate, the symbol (ii) refers to the electric potential of the other of the comb-shaped electrodes constituting the upper layer of the lower substrate, the symbol (iii) refers to the electric potential of the planar electrode constituting the lower layer of the lower substrate, and the symbol (iv) refers to the electric potential of the planar electrode of the upper substrate, unless otherwise stated. The two pairs of electrodes preferably consist of electrodes of (i) and (ii) and electrodes of (iii) and (iv), but the effect of the present invention can be achieved with any other structures.

### Embodiment 1

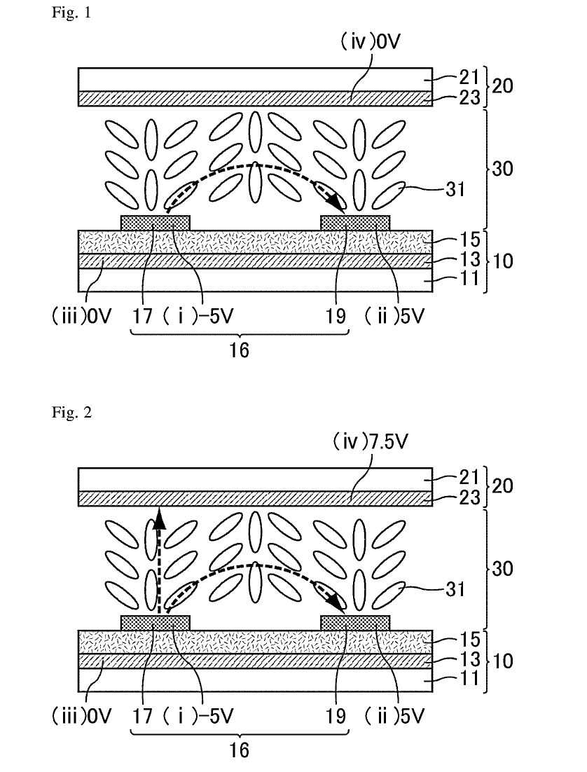

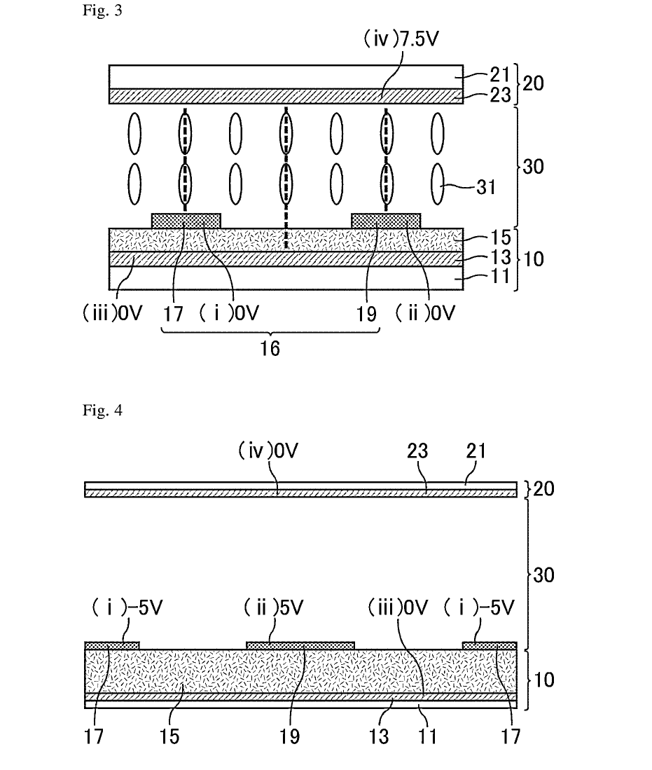

FIG. 1 is a schematic cross-sectional view of a liquid crystal display device in the presence of a transverse electric field under the first driving operation of Embodiment 1. FIG. 2 is a schematic cross-sectional view of a liquid crystal display device in the presence of a vertical electric field and a transverse electric field under the second driving operation of Embodiment 1. FIG. 3 is a schematic cross-sectional view of a liquid crystal display device in the presence of a vertical electric field under the second driving operation of Embodiment 1.

In each of FIG. 1 to FIG. 3, the dot line indicates the direction of an electric field generated. The liquid crystal display device of Embodiment 1 has a vertical-alignment three-layered electrode structure (the upper electrode on the lower substrate, which serves as the second layer, is a pair of comb-shaped electrodes) using liquid crystal molecules 31 which are positive liquid crystals.

In the liquid crystal display device using a positive liquid crystal of which the initial alignment is vertical alignment, the electrodes are in three layers [(1) counter electrode 23 in the upper substrate, (2) upper electrodes (pair of comb-shaped electrodes 16) on the lower substrate, (3) lower electrode 13 in the lower substrate], and the lower substrate (circuit substrate) with TFTs includes (2) the pair of comb-shaped electrodes, (3) the lower electrode, and an insulating layer 15 between (2) the pair of comb-shaped electrodes 16 and (3) the lower electrode 13. That is, the liquid crystal display device of Embodiment 1 includes, as illustrated in FIGS. 1 to 3, a circuit board 10 (lower substrate), a liquid crystal layer 30, and a counter substrate 20 (color filter substrate or upper substrate) in the stated order from the back side of the liquid crystal display device to the viewer side. The liquid crystal display device of Embodiment 1 vertically aligns liquid crystal molecules when the voltage difference between the comb-shaped electrodes is lower than the threshold voltage as illustrated in FIG. 3. As illustrated in FIG. 2, when the voltage difference between the comb-shaped electrodes is equal to the threshold voltage or higher, the electric field generated between the comb-shaped electrodes 17 and 19 (the pair of comb-shaped electrodes 16), which are the upper electrode formed on the glass substrate 11 (formed in the lower substrate), tilts the liquid crystal molecules in the horizontal direction between the comb-shaped electrodes, and thereby controls the amount of transmitted light. Between the planar lower electrode (counter electrode 13) and the comb-shaped electrodes 17 and 19 (the pair of comb-shaped electrodes 16), the insulating layer 15 is sandwiched. The insulating layer 15 may be formed from an oxide film (e.g. SiO₂), a nitride film (e.g. SiN), or an acrylic resin, for example, and these materials may be used in combination. The insulating layer 15 preferably has a thickness of 0.1 to 0.5 μm if the layer is formed from an inorganic film such as SiO₂ or SiN, and preferably has a thickness of 1 to 3 μm if the layer is formed from an organic film such as JAS.

At ordinary temperature, only the first driving operation (driving method) of driving with a transverse electric field (transverse electric field between comb-shaped electrodes), which provides a high transmittance, is used.

At ordinary temperature, as illustrated in FIG. 1, liquid crystal molecules are rotated by a transverse electric field generated by a potential difference of 10 V between the pair of electrodes 16 (e.g. the comb-shaped electrode 17 with an electric potential of −5 V and the comb-shaped electrode 19 with an electric potential of 5 V). At this time, a potential difference is not substantially generated between the substrates (between the counter electrode 13 with an electric potential of 7 V and the counter electrode 23 with an electric potential of 7 V). This driving operation is also referred to as the first driving operation herein. The first driving operation drives liquid crystals by a transverse electric field only, and thus gives a high transmittance and provides particularly excellent visibility.

At low temperature where the viscosity of the liquid crystals increases to delay the response, the mode is switched to a combination mode of a transverse electric field and a vertical electric field which can provide high-speed driving (the second driving operation described in, for example, the later-described Embodiment 5) with use of a temperature sensor. That is, at low temperature, the liquid crystals are driven by combination use of the transverse electric field between the comb-shaped electrodes and the vertical electric field between the upper and lower substrates (FIG. 2) in rising, and the liquid crystals are driven by the vertical electric field between the substrates in falling (FIG. 3). The temperature sensor can measure the surface temperature of the liquid crystal panel (viewer side) in the liquid crystal display device, for example. This temperature can be measured by bonding a thermocouple to the glass surface, for example.

In rising, as illustrated in FIG. 2, the liquid crystal molecules are rotated by a transverse electric field generated by a potential difference of 10 V between the pair of comb-shaped electrodes 16 (e.g. the comb-shaped electrode 17 with an electric potential of −5 V and the comb-shaped electrode 19 with an electric potential of 5 V). At this time, a vertical electric field is generated by a potential difference between the substrates (between the counter electrode 23 with an electric potential of 7.5 V and a set of the comb-shaped electrode 17 with an electric potential of −5 V and the lower electrode 13 with an electric potential of 0 V).

In falling, as illustrated in FIG. 3, the liquid crystal molecules are rotated by a vertical electric field generated by a potential difference of 7.5 V between the substrates (e.g. between the counter electrode 23 with an electric potential of 7.5 V and a set of the lower electrode 13, the comb-shaped electrode 17, and the comb-shaped electrode 19 each with an electric potential of 0 V). At this time, a potential difference is not substantially generated between the pair of substrates 16 (between the comb-shaped electrode 17 with an electric potential of 0 V and the comb-shaped electrode 19 with an electric potential of 0 V).

At low temperature, a high response speed is achieved by rotating the liquid crystal molecules by an electric field in both rising and falling. This driving operation is also referred to as the second driving operation herein. That is, the transverse electric field between the pair of comb-shaped electrodes is used to switch to the ON state to give a high transmittance in rising, and the vertical electric field between the substrates is used to switch to the ON state to give a high response speed in falling. In addition, the transverse electric field by comb driving leads to an even higher transmittance. Embodiment 1 and the following embodiments utilize positive liquid crystals as the liquid crystals, but negative liquid crystals may be used instead of the positive liquid crystals. When the negative liquid crystals are used, the potential difference between the pair of substrates aligns the liquid crystal molecules in the horizontal direction, and the potential difference between the pair of comb-shaped electrodes aligns the liquid crystal molecules in the vertical direction. Here, as well as the sufficiently high transmittance, a high response speed can be achieved by rotating the liquid crystal molecules by an electric field in both rising and falling.

The present invention can prevent display deterioration caused by response deterioration at low temperature, such as a decrease in (1) visibility (high contrast ratio, high transmittance) at ordinary temperature and (2) safe visibility at the start of operation (instrument panel, multi-view monitor system at low temperature) which are particularly required for in-vehicle devices.

Although not illustrated in FIG. 1 and FIG. 3, a polarizing plate is disposed on each substrate on the side opposite to the liquid crystal layer. The polarizing plate may be a circularly polarizing plate or may be a linearly polarizing plate. An alignment film is disposed on the liquid crystal layer side of each substrate. The alignment films each may be an organic alignment film or an inorganic alignment film as long as they align the liquid crystal molecules orthogonally to the film surface.

The liquid crystal display device of Embodiment 1 applies, through a thin-film transistor (TFT) element, a voltage supplied from an image signal line to the comb-shaped electrode 19 which drives the liquid crystals at a suitable time specified through the scanning line. The comb-shaped electrode 17 and the comb-shaped electrode 19 are formed in the same layer in the present embodiment. The comb-shaped electrodes are preferably formed in the same layer, but may be formed in different layers if the effect of the present invention of increasing the transmittance is achieved by creating a voltage difference between the comb-shaped electrodes to generate a transverse electric field. The comb-shaped electrode 19 is connected to a drain electrode that extends from the TFT through a contact hole. In FIG. 1 to FIG. 3, the counter electrodes 13 and 23 have a planar shape, and the counter electrode 13 includes commonly connected portions corresponding to even-numbered lines of the gate bus lines and commonly connected portions corresponding to odd-numbered lines of the gate bus lines. Such an electrode is also referred to as a planar electrode herein. The counter electrode 23 is commonly connected to all the pixels.

The thin-film transistor element is preferably an oxide semiconductor TFT (e.g. IGZO) from the viewpoint of increasing the transmittance. The oxide semiconductor shows higher carrier mobility than amorphous silicon. The oxide semiconductor can therefore decrease the area of a transistor in one pixel to increase the aperture ratio, such that the light transmittance per pixel can be increased. Therefore, use of an oxide semiconductor TFT can significantly achieve the effect of increasing the transmittance which is one effect of the present invention.

In the present embodiments, the electrode width L of a tooth of each comb-shaped electrode is preferably 2 μm or greater, for example, and the electrode space S for the comb-shaped electrodes is 2 μm or greater, for example. The preferred upper limit for each of the electrode width L and the electrode space S is 7 μm, for example. The ratio (L/S) between the electrode space S to the electrode width L is preferably 0.4 to 3, for example. The lower limit is more preferably 0.5, and the upper limit is more preferably 1.5.

The cell gap d may be 2 μm to 7 μm, and is preferably in this range. The cell gap d (thickness of the liquid crystal layer) is preferably calculated by averaging the thicknesses throughout the liquid crystal layer in the liquid crystal display device.

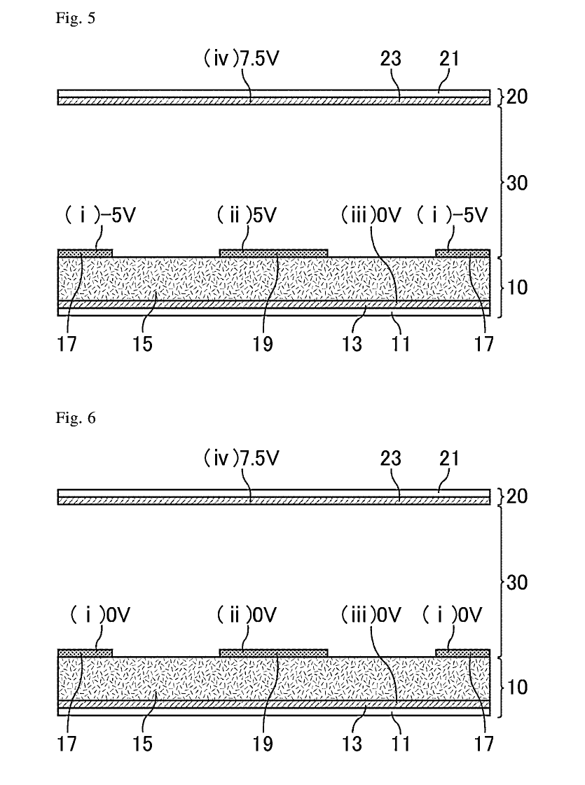

FIG. 4 is a schematic cross-sectional view of a liquid crystal display device at ordinary temperature (in the presence of a transverse electric field) under the first driving operation of Embodiment 1. FIG. 5 is a schematic cross-sectional view of a liquid crystal display device at low temperature (in the presence of a vertical electric field and a transverse electric field) under the second driving operation of Embodiment 1. FIG. 6 is a schematic cross-sectional view of a liquid crystal display device at low temperature (in the presence of a vertical electric field) under the second driving operation of Embodiment 1.

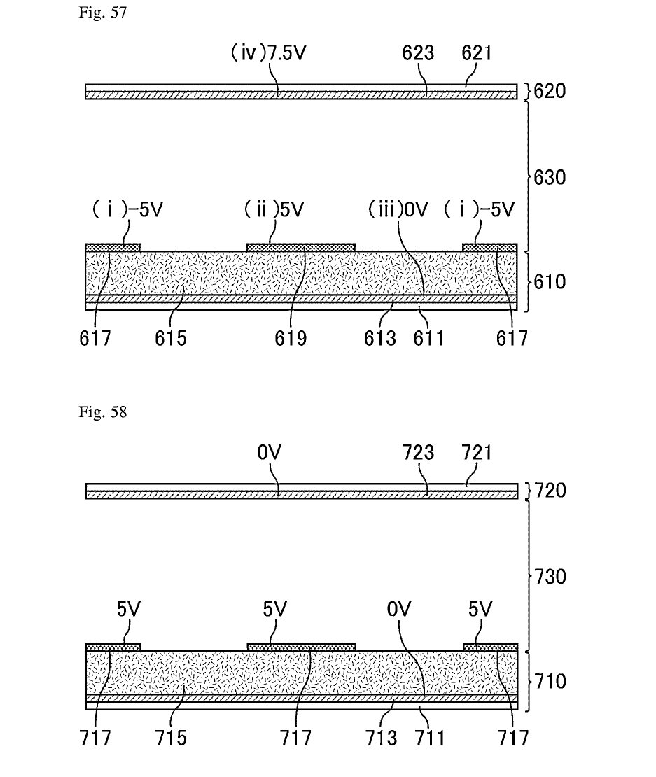

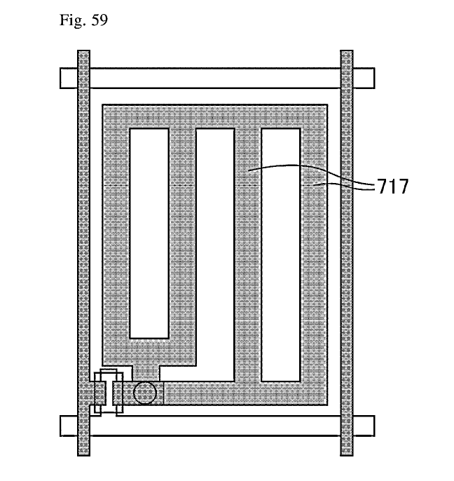

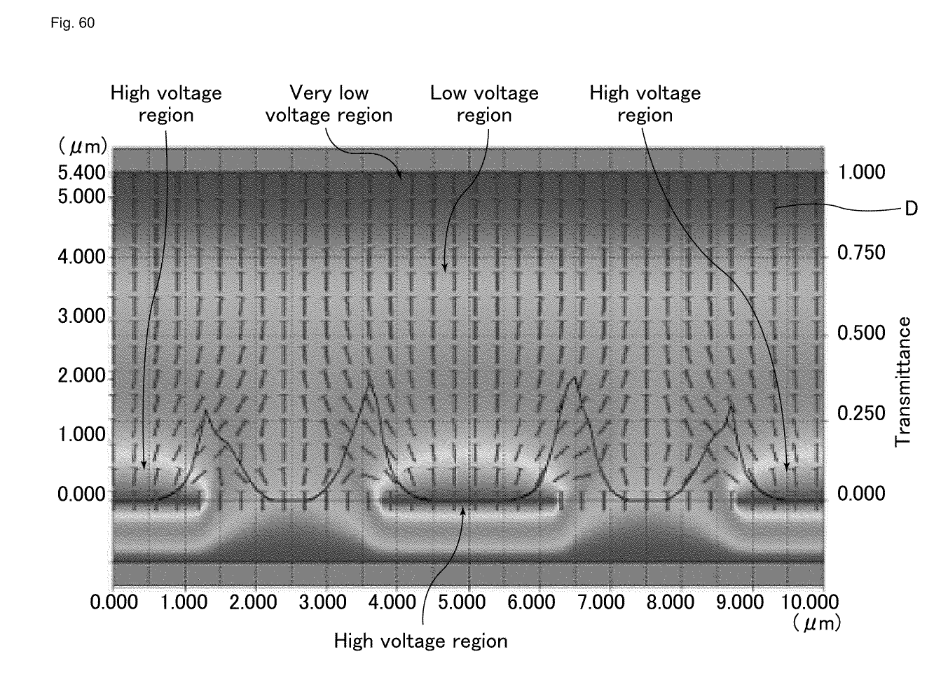

The present invention switches the driving modes of the liquid crystal display panel as described above, so as to achieve a high contrast ratio and a high transmittance (and also sufficiently high response speed) at ordinary temperature, and to switch the mode to the high-speed driving mode at low temperature. The present invention is different from conventional examples (e.g. FIG. 56, FIG. 57) in that, at ordinary temperature, the voltage of the counter electrode in the counter substrate is set to 0 V, and the voltage of the lowermost electrode is also set to 0 V, so that the driving is performed by the transverse electric field between the comb-shaped electrodes only (FIG. 4). At low temperature, the voltage of the counter electrode in the counter substrate is set to 7.5 V to generate a vertical electric field, and thereby the high response speed is achieved by the ON-ON switching (FIG. 5, FIG. 6).

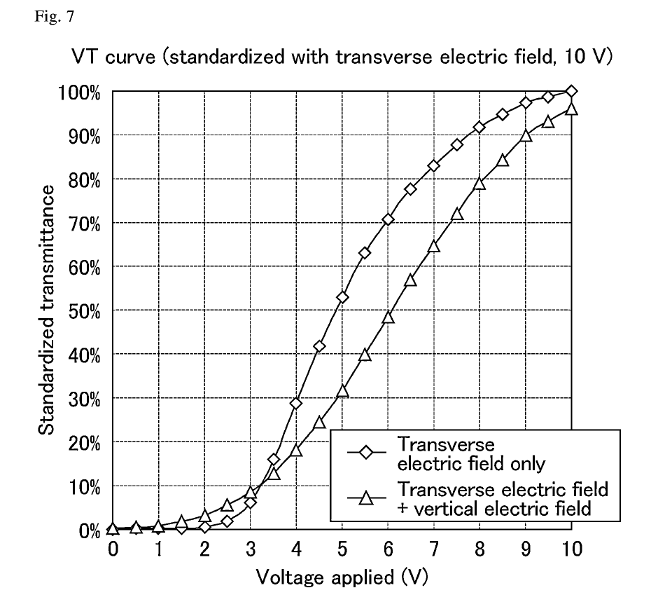

FIG. 7 is a graph showing a standardized transmittance in response to the applied voltage in the presence of a transverse electric field under the first driving operation and in the presence of a vertical electric field and a transverse electric field under the second driving operation. FIG. 7 shows a VT curve in the case of ON-ON switching mode utilizing ordinary-temperature driving (transverse electric field) and low-temperature driving (transverse electric field+vertical electric field) (e.g. Embodiment 1 and the later-described Embodiment 5 in each of which a vertical electric field and a transverse electric field are used in rising while a vertical electric field is used in falling). The ON-ON switching driving of generating a vertical electric field in rising is observed to decrease the transmittance by 5%. Also in the ON-ON switching which utilizes a transverse electric field in rising and a vertical electric field in falling (Embodiments 2 to 4), the use of the vertical electric field in falling decreases the transmittance compared to the case of the driving operation utilizing a transverse electric field only.

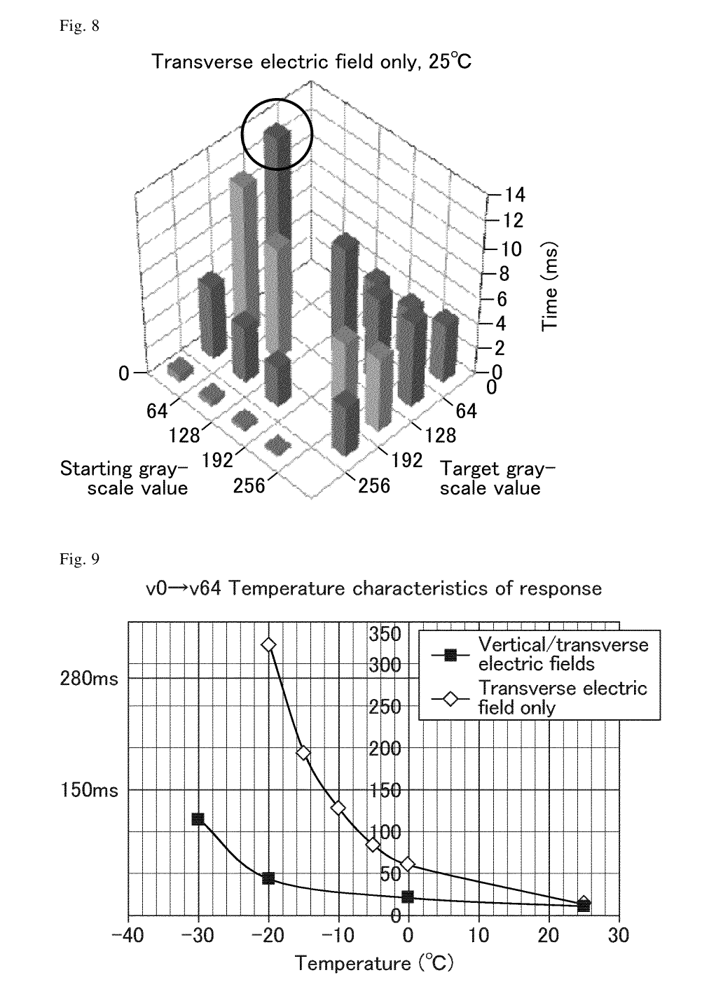

FIG. 8 is a graph showing the gray-scale response at 25° C. under the driving with a transverse electric field. FIG. 8 shows time (ms) required to provide a response in gray-scale driving from a specific starting gray-scale value to a specific target gray-scale value in the gray-scale response by the transverse electric field driving at ordinary temperature (25° C.). The latest gray-scale response was the rise from a gray-scale value of 0 to a gray-scale value of 64 (the response marked by a circle). Although not illustrated, the same tendency was seen at low temperature.

FIG. 9 is a graph showing the temperature characteristics of response from a gray-scale value of 0 to a gray-scale value of 64 under the driving with a transverse electric field. The horizontal axis indicates the temperature (° C.) and the vertical axis indicates the response time (ms) from a gray-scale value of 0 to a gray-scale value of 64. The visibility at low temperature which is required for an in-vehicle display device is favorable if the response time for all the gray-scale values is 280 ms or slower. FIG. 9 shows the temperature characteristics of the slowest response between gray-scale values (temperature characteristics of response from a gray-scale value of 0 to a gray-scale value of 64). Here, if the driving is switched from the driving preferentially increasing the transmittance (driving by a transverse electric field only) to high-speed driving (driving by a vertical electric field and a transverse electric field (vertical/transverse electric field)) at −18° C. or higher (e.g. −18° C.) using a temperature sensor, the response time between gray-scale values would not be longer than 280 ms, which leads to favorable visibility.

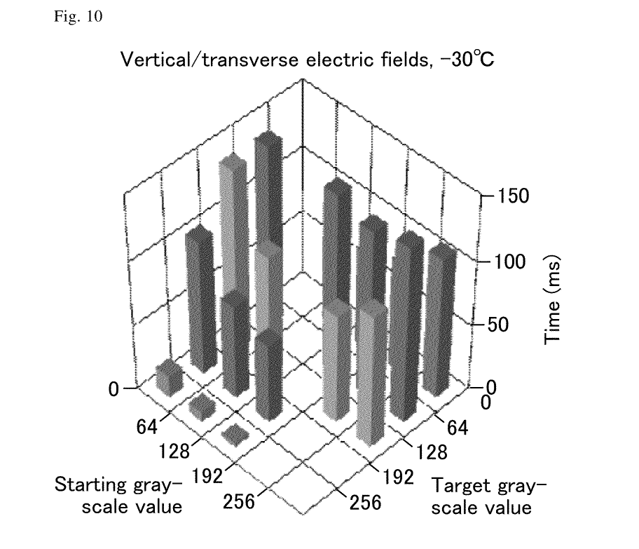

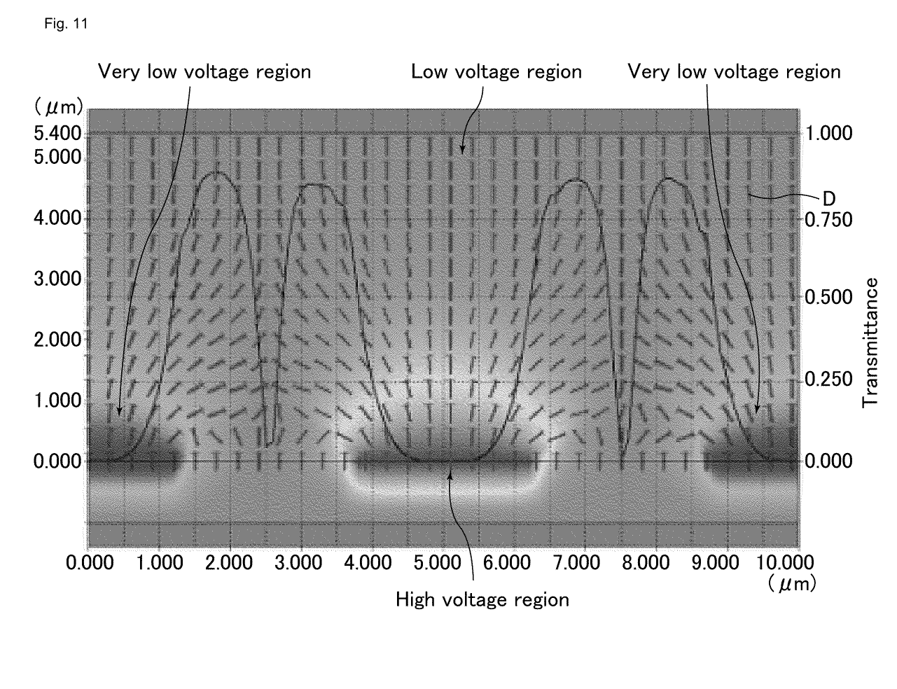

FIG. 10 is a graph showing a gray-scale response at −30° C. under low-temperature driving. FIG. 10 indicates the time (ms) required for response between gray-scale values from a specific starting gray-scale value to a specific target gray-scale value in gray-scale response by driving utilizing a transverse electric field and a vertical electric field in combination at low temperature (−30° C.). FIG. 10 indicates that the response time between all the gray-scale values is 150 ms or shorter, which indicates that the response at low temperature is excellent. If driving voltage overshoot occurs, even better response can be achieved.

From FIG. 9, the temperature under ordinary-temperature driving which gives a response between all the gray-scale values of 150 ms or shorter to eliminate the discomfort in the visibility in switching of driving is apparently about −10° C.

That is, a decrease in the visibility caused by the delay of response at low temperature can be well prevented if the driving which utilizes a transverse electric field only and provides good visibility (high contrast ratio, high transmittance) is used at a temperature not lower than −18° C., and the driving is switched to the vertical electric field at −18° C. or lower.

Furthermore, switching of the driving at −10° C. provides no difference in the response speed from ordinary temperature to low temperature to achieve favorable visibility. For example, a switching temperature of −4° C. to −12° C. is particularly preferred.

The liquid crystal display device of Embodiment 1 can appropriately include the components (e.g. light source) provided to common liquid crystal display devices. The same applies to the embodiments described later.

### (TFT Driving Method of Second Driving Operation)

An example of driving by the second driving operation of changing the voltage applied to the counter electrode in the presence of the vertical electric field to 0 V (or 15 V) is described below (2-TFT driving and 1-TFT driving are described). Also, embodiments are mentioned which provide an increased transmittance by providing a dielectric layer (also referred to as an overcoat layer or OC layer) on the counter substrate. The driving method (second driving operation) of the liquid crystal display device of the later-described embodiment can be suitably applied to the concept of the present invention to achieve a sufficiently high transmittance and a high-speed response. The first driving operation in the later-described embodiments can be the same as the first driving operation of Embodiment 1 described above.

### Embodiment 2

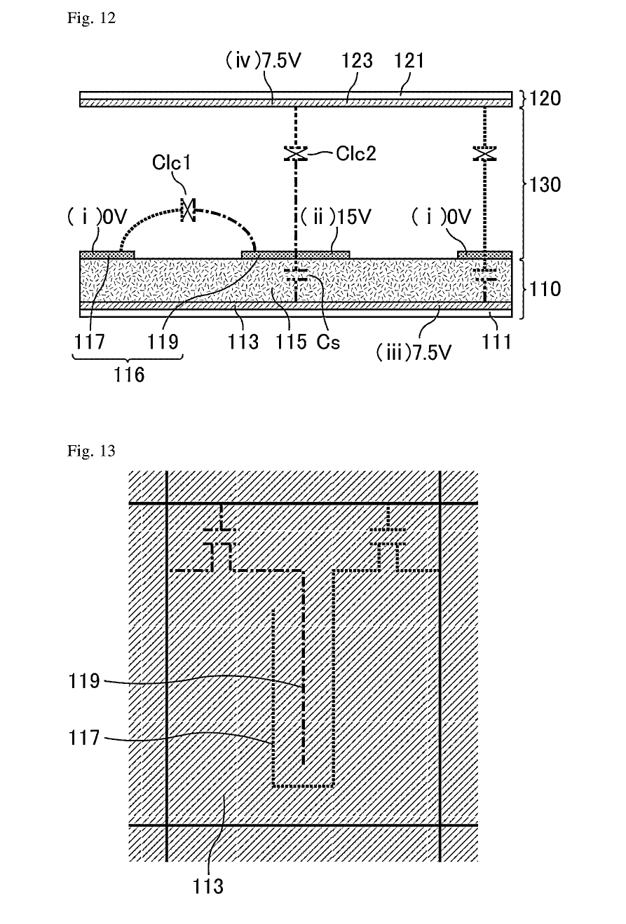

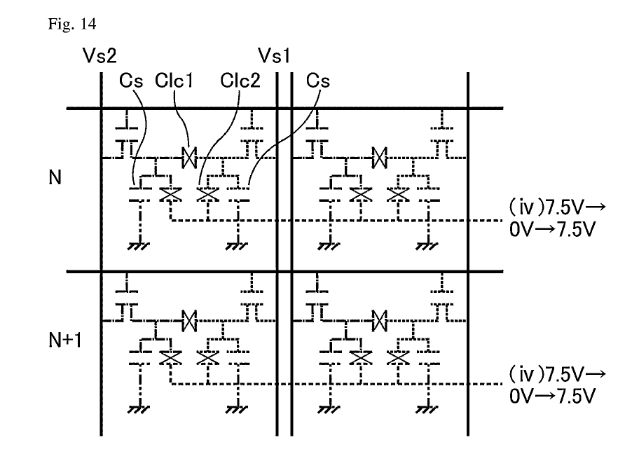

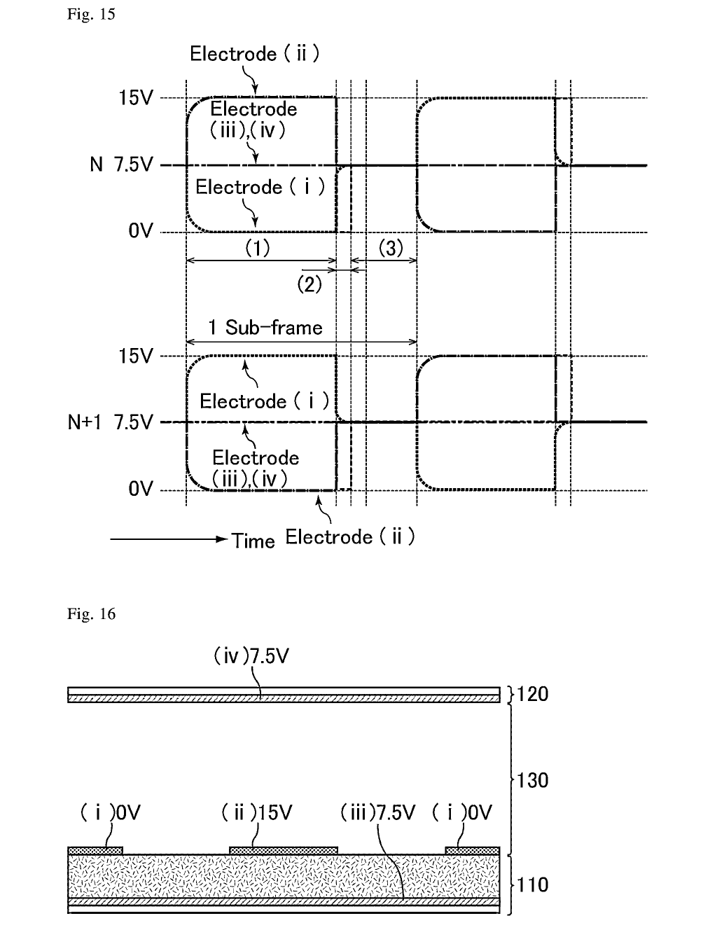

FIG. 12 is a schematic cross-sectional view of a liquid crystal display panel of Embodiment 2. FIG. 13 is a schematic plan view of a sub-pixel in the liquid crystal display panel of Embodiment 2. FIG. 14 is a view of a sub-pixel equivalent circuit of the liquid crystal display panel of Embodiment 2. FIG. 15 is a view showing a potential change of electrodes in the liquid crystal display panel of Embodiment 2. The driving method by the module in Embodiment 2 is driving two TFTs per sub-pixel. In FIG. 12 to FIG. 15, a wiring electrically connected to the lower electrode of the lower substrate is indicated by a two-dot chain line. A wiring electrically connected to one of the pair of comb-shaped electrodes on the lower substrate is indicated by a one-dot chain line. A wiring electrically connected to the other of the pair of the comb-shaped electrodes on the lower substrate is indicated by a closely spaced dotted line. A wiring electrically connected to the electrode in the upper substrate is indicated by a widely spaced dotted line. A lower electrode 113 serves also as a Cs electrode, and is commonly connected to all the pixels. In FIG. 71, Cs indicates an auxiliary capacity formed by the overlapped comb-shaped electrodes and the Cs electrode, Clc1 indicates a liquid crystal capacity formed between the pair of comb-shaped electrodes, and Clc2 indicates a liquid crystal capacity formed between the electrodes of the pair of substrates.

In the Nth-line sub-pixels, a voltage applied to the counter electrode (iv) on the counter substrate side is 7.5 V during bright display, is 0 V during dark display (black display) after the bright display, and is 7.5 V in the initialization process of equalizing the voltages applied to all the electrodes. Also in the (N+1)st-line sub-pixels, a voltage applied to the counter electrode (iv) on the counter substrate side is 7.5 V during bright display, is 0 V during dark display (black display) after the bright display, and is 7.5 V in the initialization process of equalizing the voltages applied to all the electrodes. Here, the Nth line may be an even-numbered line and the (N+1)st line may be an odd-numbered line, or the Nth line may be an odd-numbered line and the (N+1)st line may be an even-numbered line. In Embodiment 2, a voltage applied to the counter electrode (iv) on the counter substrate side commonly connected to all the pixels is changed, and thereby a vertical electric field is generated in the region (2) illustrated in FIG. 16. Although the electric potential of the electrode kept at a certain voltage is 7.5 V, this electric potential can be regarded substantially as 0 V. Accordingly, the Nth line and the (N+1)st line are also considered to be driven by inverting the polarities.

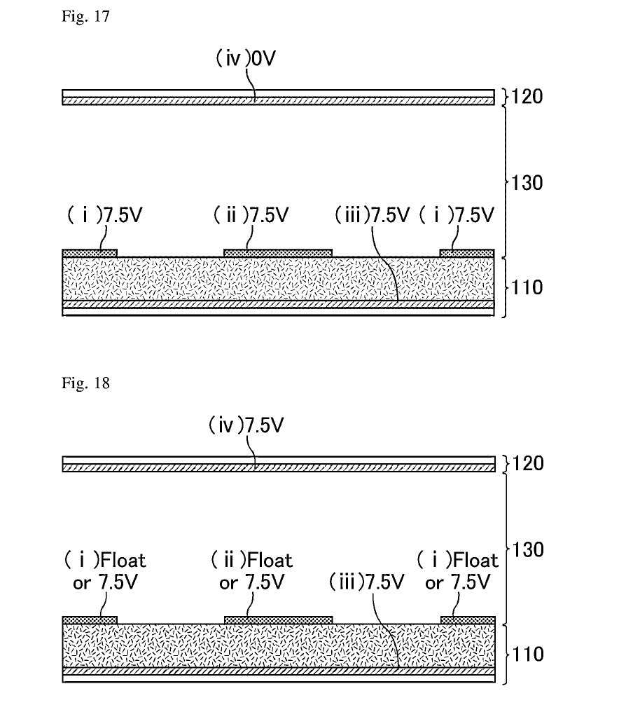

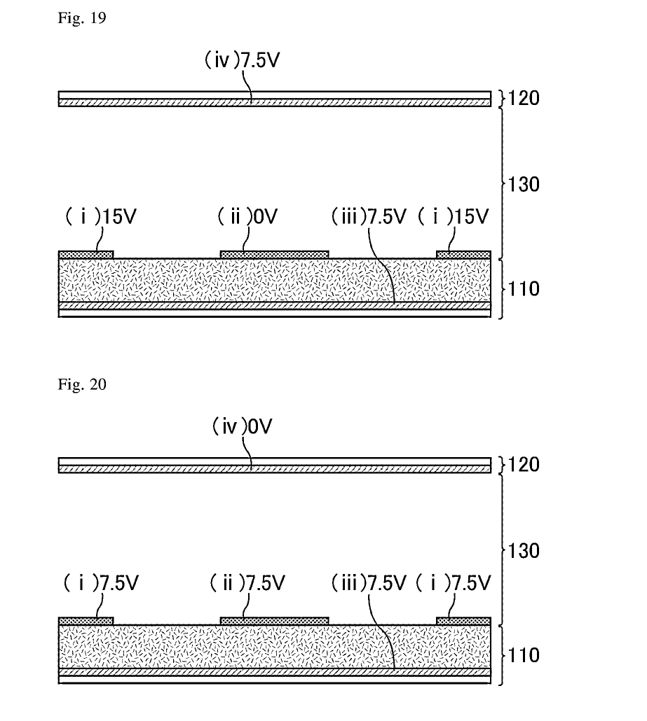

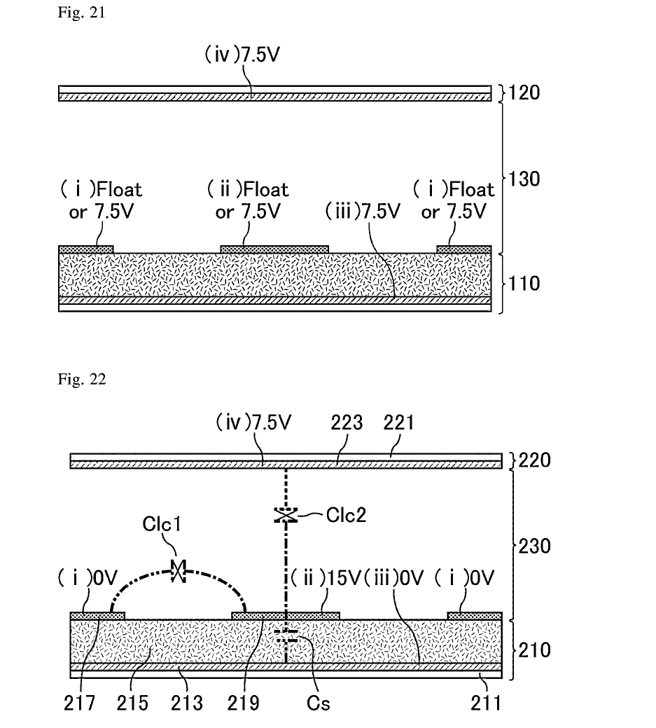

FIG. 16 is a schematic cross-sectional view illustrating the electrodes in the Nth line in the liquid crystal display panel of Embodiment 2 in the presence of a transverse electric field. FIG. 17 is a schematic cross-sectional view illustrating the electrodes in the Nth line in the liquid crystal display panel of Embodiment 2 in the presence of a vertical electric field. FIG. 18 is a schematic cross-sectional view illustrating the electrodes in the Nth line in the liquid crystal display panel of Embodiment 2 in the initialization process after generation of a vertical electric field. FIG. 19 is a schematic cross-sectional view illustrating the electrodes in the (N+1)st line in the liquid crystal display panel of Embodiment 2 in the presence of a transverse electric field. FIG. 20 is a schematic cross-sectional view illustrating the electrodes in the (N+1)st line in the liquid crystal display panel of Embodiment 2 in the presence of a vertical electric field. FIG. 21 is a schematic cross-sectional view illustrating the electrodes in the (N+1)st line in the liquid crystal display panel of Embodiment 2 in the initialization process after generation of a vertical electric field.

In FIG. 16 and FIG. 19, the liquid crystals are driven by a transverse electric field between the pair of comb-shaped electrodes. In FIG. 17 and FIG. 20, both the comb-shaped electrodes and the lower electrode are at 7.5 V, and the counter electrode on the counter substrate side is at 0 V, so that a vertical electric field is generated. In FIG. 18 and FIG. 21, the alignment is refreshed (initialization process is conducted) to provide the initial alignment with all the electrodes at 7.5 V (the pair of comb-shaped electrodes may float). The other reference numerals in the figures relating to Embodiment 2 are the same as those in the figures relating to Embodiment 1, except that a numeral “1” was added as the hundred's digit.

In Embodiment 2, a vertical electric field is generated by changing the voltage applied to the counter electrode commonly connected to all the pixels as described above. Thereby, it is possible and suitable to drive liquid crystals utilizing the counter electrode and the lower electrode which are commonly connected to all the pixels. That is, the counter electrode and the lower electrode may each be a planar electrode common in all the pixels, or may each be an electrode commonly connected in the even-numbered or odd-numbered line along the bus lines such as scanning lines. If the electrodes are each a planar electrode common in all the pixels, elements can be simplified.

Here, (1) a transverse electric field was generated by dot inversion driving, and (2) a vertical electric field was generated by frame inversion driving.

The other configurations in Embodiment 2 are the same as those described above for Embodiment 1.

### Embodiment 3

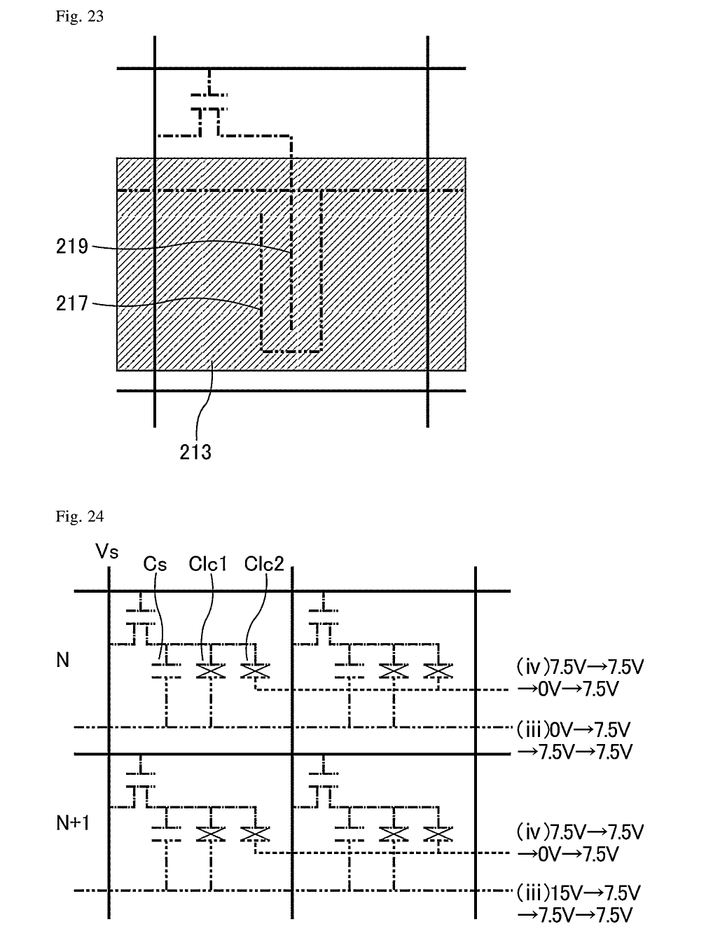

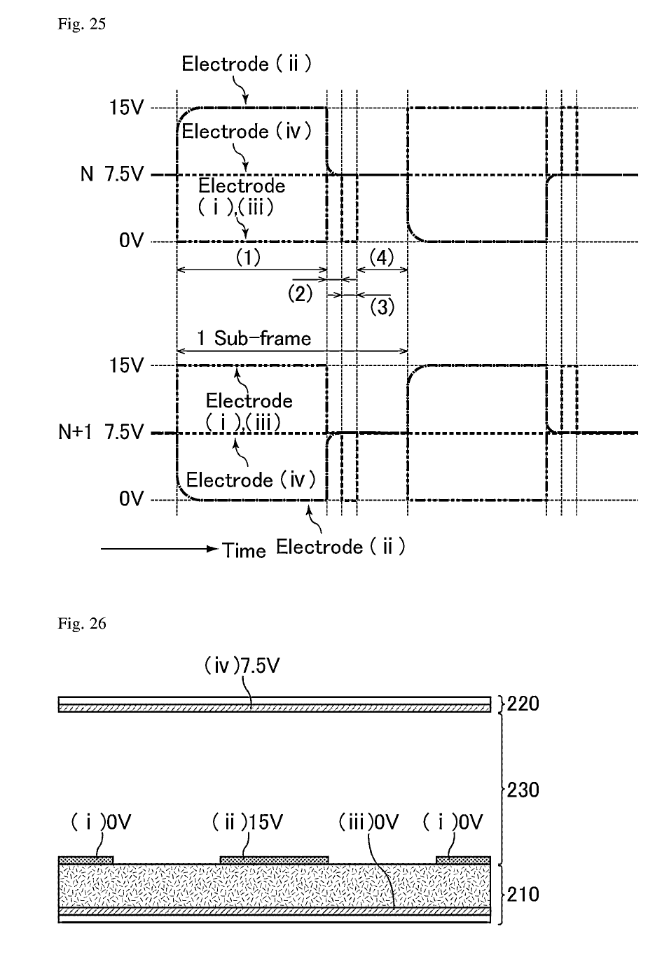

FIG. 22 is a schematic cross-sectional view of a liquid crystal display panel of Embodiment 3. FIG. 23 is a schematic plan view of a sub-pixel in the liquid crystal display panel of Embodiment 3. FIG. 24 is a view of a sub-pixel equivalent circuit of the liquid crystal display panel of Embodiment 3. FIG. 25 is a view showing a potential change of electrodes in the liquid crystal display panel of Embodiment 3. The driving method for modules in Embodiment 3 drives one TFT per sub-pixel. In FIG. 22 to FIG. 25, a wiring electrically connected to the lower electrode of the lower substrate is indicated by a two-dot chain line. A wiring electrically connected to one of the pair of comb-shaped electrodes on the lower substrate is indicated by a one-dot chain line. A wiring electrically connected to the other of the pair of comb-shaped electrodes on the lower substrate is indicated by a two-dot chain line because the other of the pair of comb-shaped electrode is electrically connected to the lower electrode of the lower substrate. A wiring electrically connected to the electrode in the upper substrate is indicated by a dotted line. The lower electrode serves also as a Cs electrode, and is commonly connected in even-numbered or odd-numbered lines.

In the Nth-line sub-pixels, the voltage applied to the lower electrode (iii) is 0 V during bright display, and during dark display (black display) after the bright display, the voltage starts from 7.5 V (all the TFTs are turned on) in the initialization process, is 7.5 V in the presence of a vertical electric field, and is 7.5 V in the initialization process after the generation of the vertical electric field. The voltage applied to the counter electrode (iv) on the counter substrate side is 7.5 V during bright display, and during dark display (black display) after the bright display, the voltage starts from 7.5 V (all the TFTs are turned on) in the initialization process, is 0 V in the presence of a vertical electric field, and is 7.5 V in the initialization process after the generation of the vertical electric field. In the (N+1)st-line sub-pixels, a voltage applied to the lower electrode (iii) is 15 V during bright display, and during dark display (black display) after the bright display, the voltage starts from 7.5 V (all the TFTs are turned on) in the initialization process, is 7.5 V in the presence of a vertical electric field, and is 7.5 V in the initialization process after the generation of the vertical electric field. The voltage applied to the counter electrode (iv) in the counter substrate is 7.5 V during bright display, and during dark display (black display) after the bright display, the voltage starts from 7.5 V (all the TFTs are turned on) in the initialization process, is 0 V in the presence of a vertical electric field, and is 7.5 V in the initialization process after the generation of the vertical electric field. Here, the Nth line may be an even-numbered line and the (N+1)st line may be an odd-numbered line, or the Nth line may be an odd-numbered line and the (N+1)st line may be an even-numbered line. In Embodiment 3, a voltage is applied to the counter electrode commonly connected to all the pixels to define vertical electric field. The counter electrode may be connected in each line as illustrated in FIG. 24. Although the electric potential of the electrode kept at a certain voltage is 7.5 V, this electric potential can be regarded substantially as 0 V. Accordingly, the Nth line and the (N+1)st line are also considered to be driven by inverting the polarities.

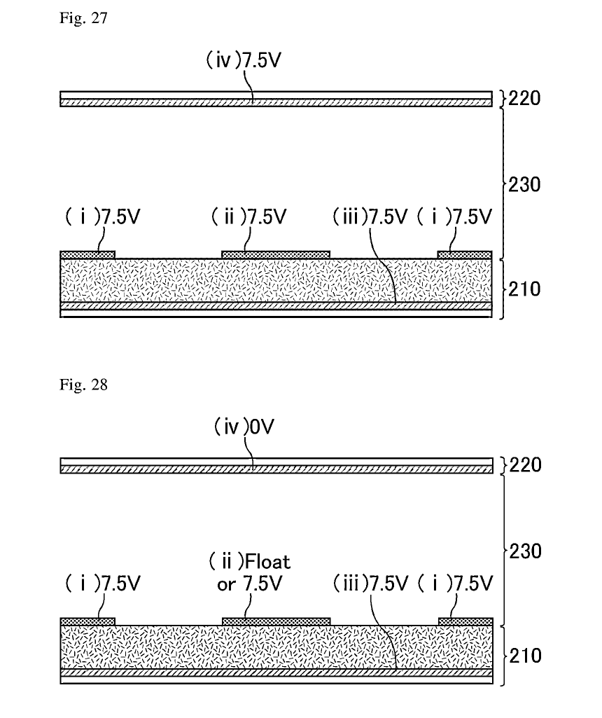

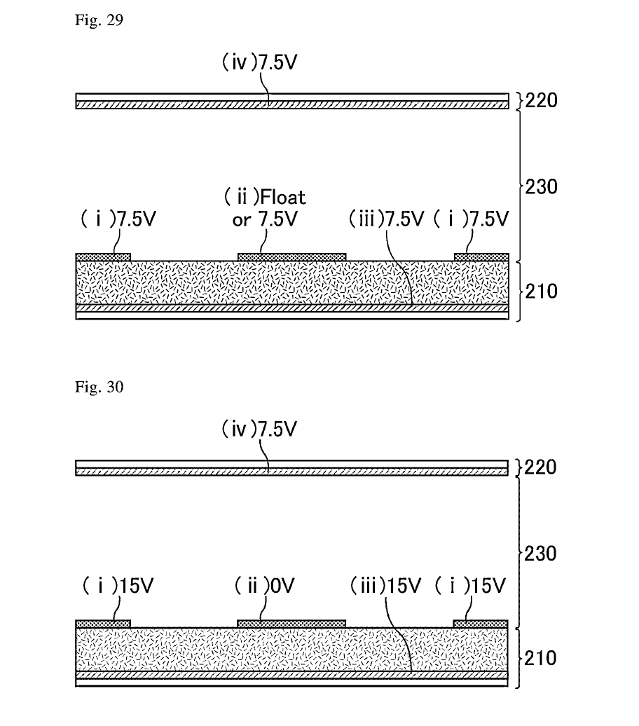

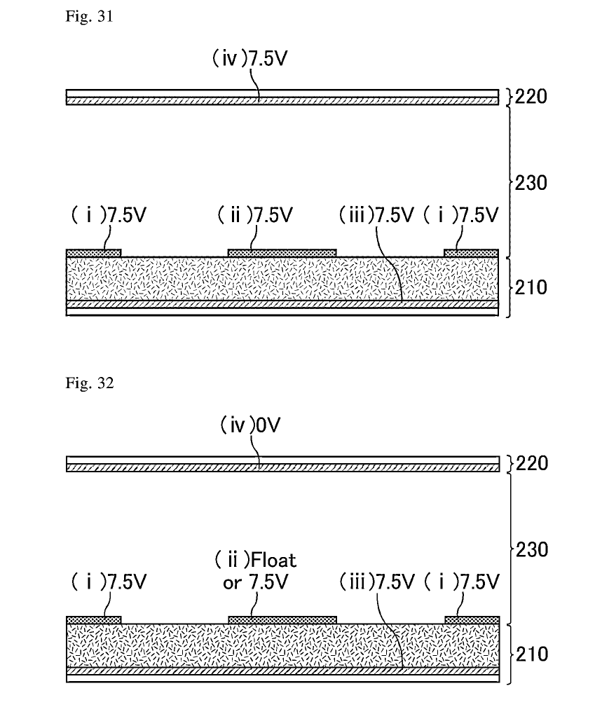

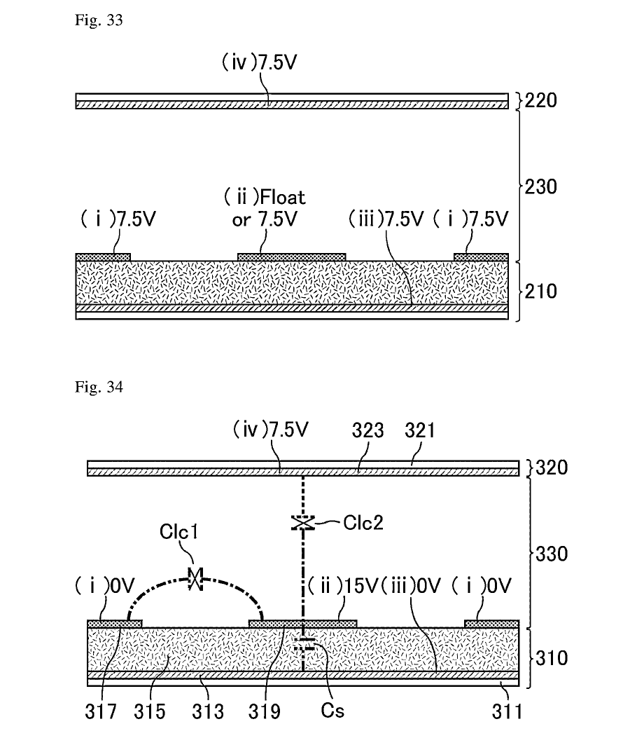

FIG. 26 is a schematic cross-sectional view illustrating the electrodes in the Nth line in the liquid crystal display panel of Embodiment 3 in the presence of a transverse electric field. FIG. 27 is a schematic cross-sectional view illustrating the electrodes in the Nth line in the liquid crystal display panel of Embodiment 3 in the initialization process after generation of a transverse electric field. FIG. 28 is a schematic cross-sectional view illustrating the electrodes in the Nth line in the liquid crystal display panel of Embodiment 3 in the presence of a vertical electric field. FIG. 29 is a schematic cross-sectional view illustrating the electrodes in the Nth line in the liquid crystal display panel of Embodiment 3 in the initialization process after generation of a vertical electric field. FIG. 30 is a schematic cross-sectional view illustrating the electrodes in the (N+1)st line in the liquid crystal display panel of Embodiment 3 in the presence of a transverse electric field. FIG. 31 is a schematic cross-sectional view illustrating the electrodes in the (N+1)st line in the liquid crystal display panel of Embodiment 3 in the initialization process after generation of a transverse electric field. FIG. 32 is a schematic cross-sectional view illustrating the electrodes in the (N+1)st line in the liquid crystal display panel of Embodiment 3 in the presence of a vertical electric field. FIG. 33 is a schematic cross-sectional view illustrating the electrodes in the (N+1)st line in the liquid crystal display panel of Embodiment 3 in the initialization process after generation of a vertical electric field.

In FIG. 26 and FIG. 30, the liquid crystals are driven by a transverse electric field between the pair of comb-shaped electrodes. In FIG. 27 and FIG. 31, all the TFTs are turned on to reset the voltages of all the electrodes to 7.5 V. In FIG. 28 and FIG. 32, the electrode in the lower substrate is at 7.5 V and the counter electrode on the counter substrate side is at 0 V, so that a vertical electric field is generated (the TFT of one of the pair of comb-shaped electrodes may be turned off so that one of the pair of comb-shaped electrodes may float). In FIG. 29 and FIG. 33, the alignment of the liquid crystals is refreshed (initialization process) with all the electrodes at 7.5 V (the TFT of one of the pair of comb-shaped electrodes may be turned off so that one of the pair of comb-shaped electrodes may float). The other reference numerals in the figures relating to Embodiment 3 are the same as those in the figures relating to Embodiment 1, except that a numeral “2” was added as the hundred's digit.

Here, (1) a transverse electric field was generated by line inversion driving, and (2) a vertical electric field was generated by frame inversion driving.

In Embodiment 2, the counter electrode and the lower electrode may each be an electrode common in all the pixels or an electrode common in the even-numbered or odd-numbered lines along the bus lines such as scanning lines.

Meanwhile, in Embodiment 3, the lower electrode used in line inversion driving is typically an electrode common in even-numbered or odd-numbered lines along the bus lines such as scanning lines. Meanwhile, the counter electrode (iv) on the counter substrate side may be commonly connected to all the pixels in Embodiment 3, or may be commonly connected in even-numbered or odd-numbered lines as illustrated in FIGS. 23 and 24.

The other configurations in Embodiment 3 are the same as those described above for Embodiment 1.

### Alternative Embodiment of Embodiment 3

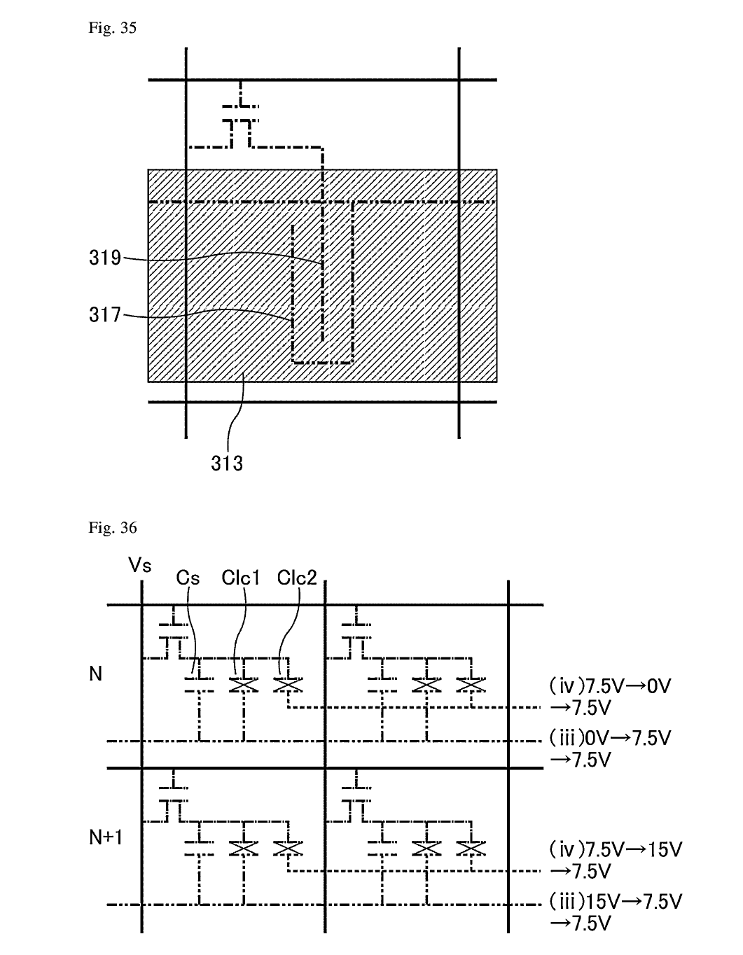

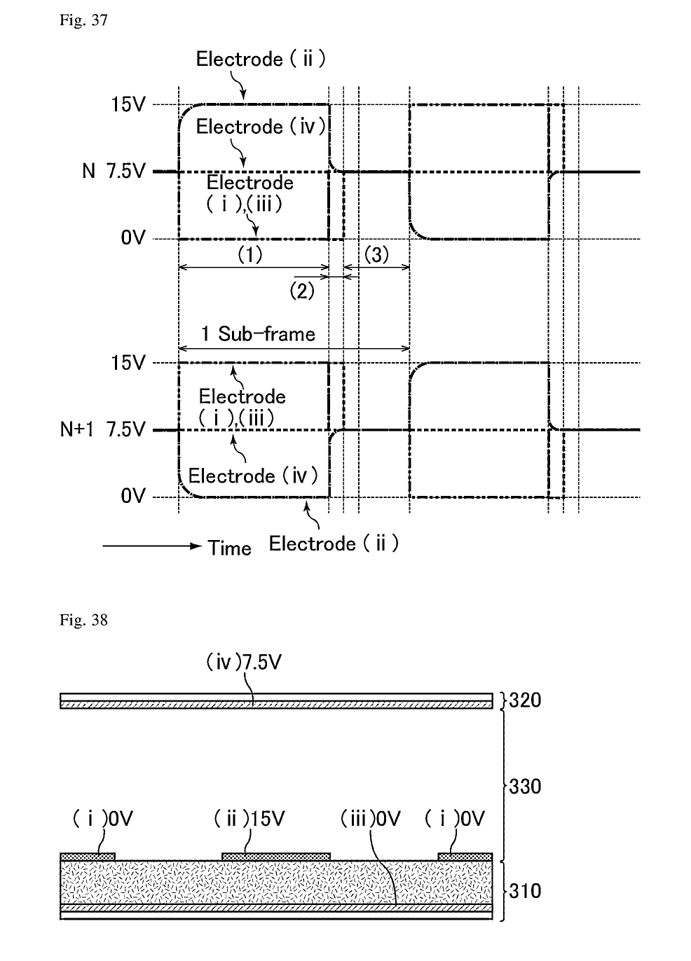

FIG. 34 is a schematic cross-sectional view of a liquid crystal display panel of an alternative embodiment of Embodiment 3. FIG. 35 is a schematic plan view of a sub-pixel in the liquid crystal display panel of the alternative embodiment of Embodiment 3. FIG. 36 is a view of a sub-pixel equivalent circuit of the liquid crystal display panel of the alternative embodiment of Embodiment 3. FIG. 37 is a view showing a potential change of electrodes in the liquid crystal display panel of the alternative embodiment of Embodiment 3. The driving method for the module in the alternative embodiment of Embodiment 3 is driving one TFT per sub-pixel. In FIG. 34 to FIG. 37, a wiring electrically connected to the lower electrode of the lower substrate is indicated by a two-dot chain line. A wiring electrically connected to one of the pair of comb-shaped electrodes on the lower substrate is indicated by a one-dot chain line. A wiring electrically connected to the other of the pair of the comb-shaped electrodes on the lower substrate is indicated by a two-dot chain line because the other of the comb-shaped electrodes is electrically connected to the lower electrode of the lower substrate. A wiring electrically connected to the electrode in the upper substrate is indicated by a dotted line. The lower electrode serves also as a Cs electrode, and is commonly connected in even-numbered or odd-numbered lines.

In the Nth-line sub-pixels, the voltage applied to the lower electrode (iii) is 0 V during bright display, is 7.5 V in the presence of a vertical electric field during dark display (black display) after the bright display, and is 7.5 V in the initialization process which provides dark display (black display). The voltage applied to the counter electrode (iv) on the counter substrate side is 7.5 V during bright display, is 0 V during dark display (black display) after the bright display, and is 7.5 V in the initialization process. In the (N+1)st-line sub-pixels, the voltage applied to the lower electrode (iii) is 15 V during bright display, is 7.5 V in the presence of a vertical electric field during dark display (black display) after the bright display, and is 7.5 V in the initialization process which provides dark display (black display). The voltage applied to the counter electrode (iv) on the counter substrate side is 7.5 V during bright display, is 15 V during dark display (black display) after the bright display, and is 7.5 V in the initialization process. Here, the Nth line may be an even-numbered line and the (N+1)st line may be an odd-numbered line, or the Nth line may be an odd-numbered line and the (N+1)st line may be an even-numbered line. In the alternative embodiment of Embodiment 3, voltages are applied to the lower electrode commonly connected in even-numbered or odd-numbered lines and to the counter electrode in the counter substrate commonly connected in even-numbered or odd-numbered lines, so that the electric potentials are inverted. In the driving of the alternative embodiment of Embodiment 3, the counter electrode (iv) on the counter substrate side may be commonly connected in all the pixels instead of being commonly connected to even-numbered or odd-numbered lines. In this case, the voltage applied to the region (2) of the electrode (iv) illustrated in FIG. 37 is 0 V at both the Nth line and the (N+1)st line, but the other electric potential changes at the other electrodes are the same as in the alternative embodiment of Embodiment 3. Although the electric potential of the electrode kept at a certain voltage is 7.5 V, this electric potential can be regarded substantially as 0 V. Accordingly, the Nth line and the (N+1)st line are also considered to be driven by inverting the polarities.

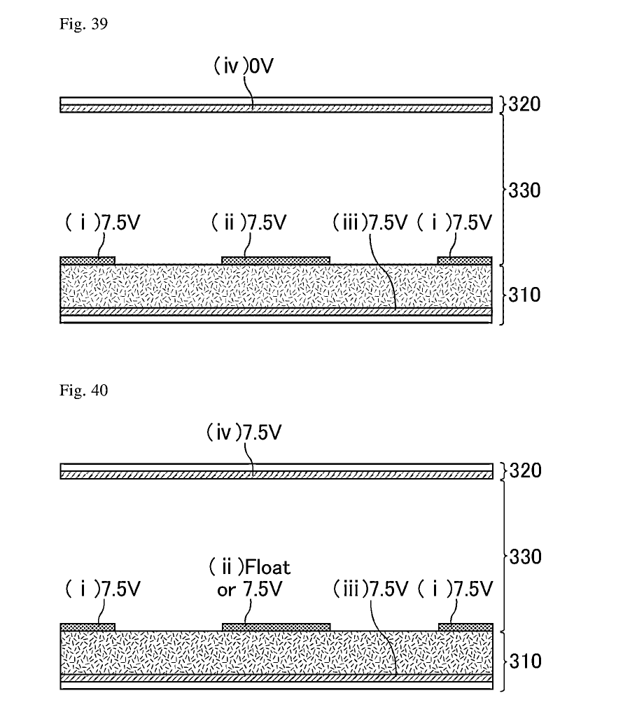

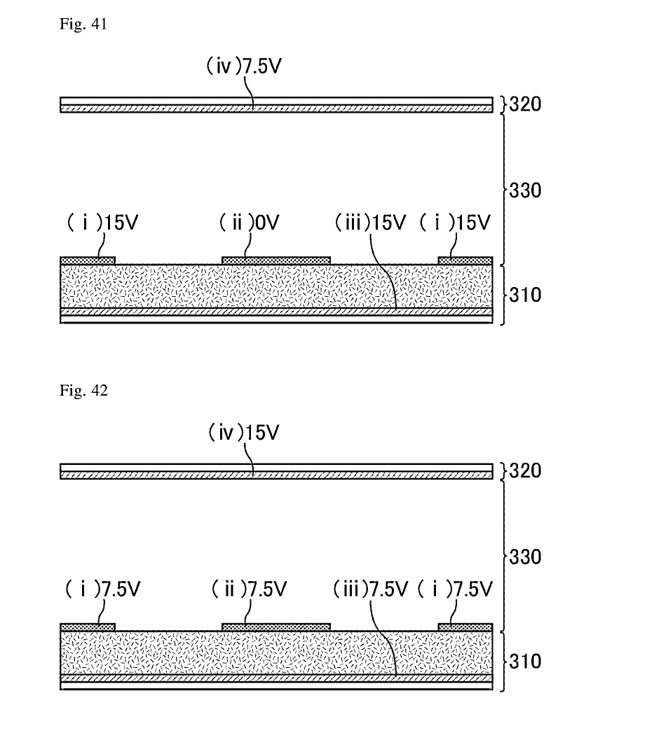

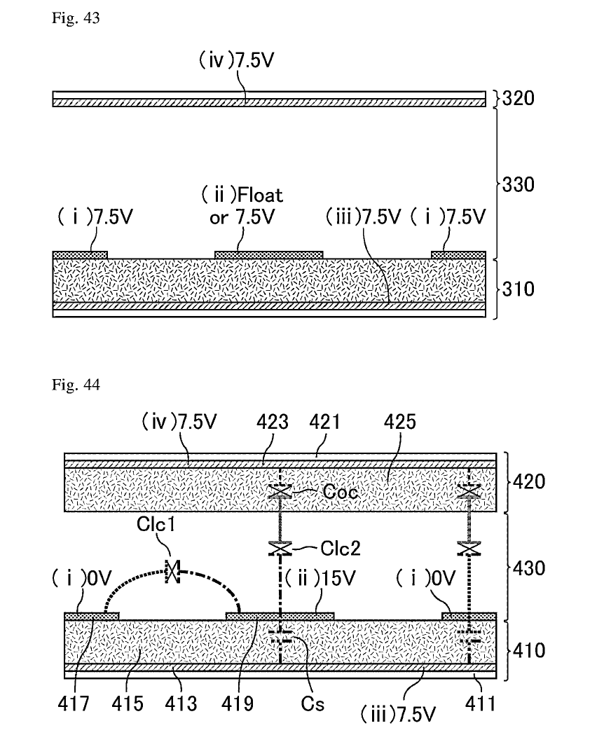

FIG. 38 is a schematic cross-sectional view illustrating the electrodes in the Nth line in the liquid crystal display panel of the alternative embodiment of Embodiment 3 in the presence of a transverse electric field. FIG. 39 is a schematic cross-sectional view illustrating the electrodes in the Nth line in the liquid crystal display panel of the alternative embodiment of Embodiment 3 in the presence of a vertical electric field. FIG. 40 is a schematic cross-sectional view illustrating the electrodes in the Nth line in the liquid crystal display panel of the alternative embodiment of Embodiment 3 in the initialization process after generation of a vertical electric field. FIG. 41 is a schematic cross-sectional view illustrating the electrodes in the (N+1)st line in the liquid crystal display panel of the alternative embodiment of Embodiment 3 in the presence of a transverse electric field. FIG. 42 is a schematic cross-sectional view illustrating the electrodes in the (N+1)st line in the liquid crystal display panel of the alternative embodiment of Embodiment 3 in the presence of a vertical electric field. FIG. 43 is a schematic cross-sectional view illustrating the electrodes in the (N+1)st line in the liquid crystal display panel of the alternative embodiment of Embodiment 3 in the initialization process after generation of a vertical electric field.

In FIG. 38 and FIG. 41, the liquid crystals are driven by a transverse electric field between the pair of comb-shaped electrodes. In FIG. 39 and FIG. 42, both the comb-shaped electrodes and the lower electrode are at 7.5 V, and the counter electrode on the counter substrate side is at 0 V or 15 V, so that a vertical electric field is generated. In FIG. 40 and FIG. 43, the alignment of the liquid crystals is refreshed (initialization process) to provide the initial alignment with all the electrodes at 7.5 V (the TFT of one of the pair of comb-shaped electrodes may be turned off so that one of the pair of comb-shaped electrodes may float). The other reference numerals in the figures relating to the alternative embodiment of Embodiment 3 are the same as those in the figures relating to Embodiment 1, except that a numeral “3” was added as the hundred's digit.

The other configurations in the alternative embodiment of Embodiment 3 are the same as those described above for Embodiment 1.

### Embodiment 4

### Same as Embodiment 2 Except that a Dielectric Layer is Provided on the Surface of the Counter Electrode; Also Regarded as an Alternative Embodiment of Embodiment 2

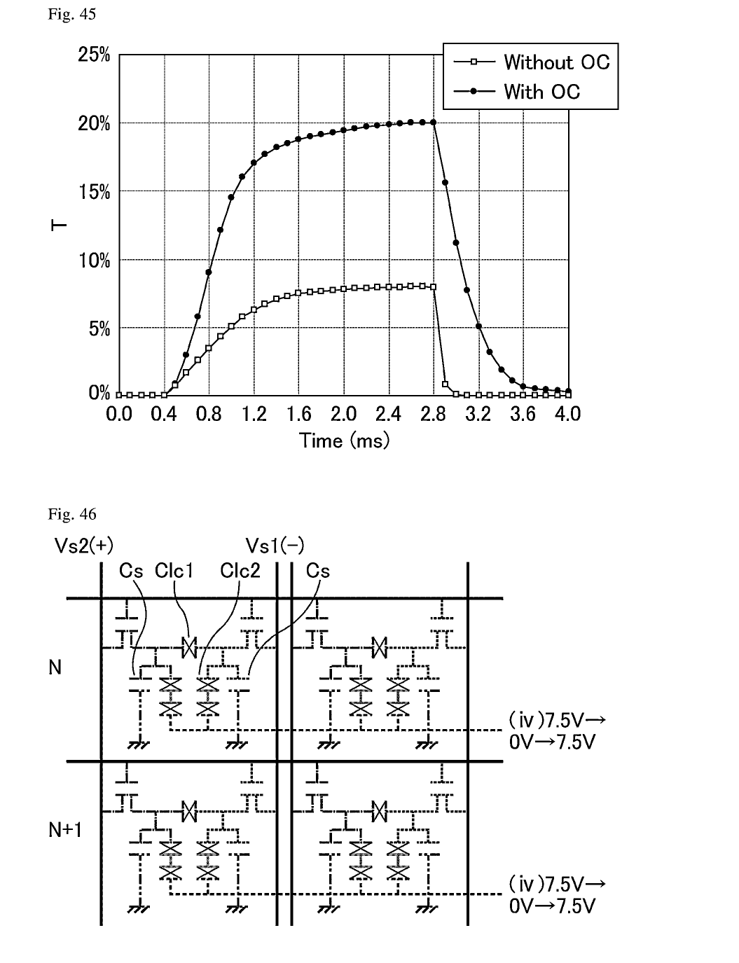

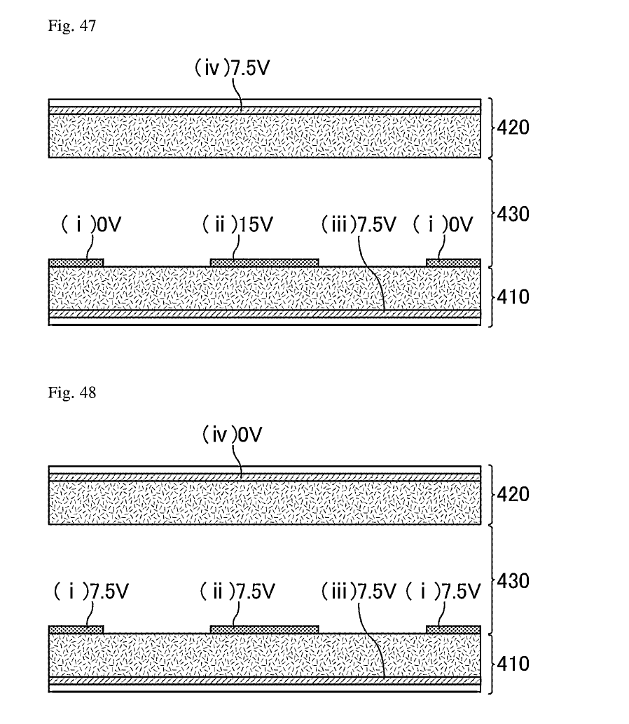

FIG. 44 is a schematic cross-sectional view of a liquid crystal display panel of Embodiment 4. FIG. 45 is a graph showing simulated response waveforms relative to the presence or absence of a dielectric layer on the surface of a counter electrode. FIG. 46 is a view of a sub-pixel equivalent circuit of the liquid crystal display panel of Embodiment 4. The driving method by the module in Embodiment 4 is driving two TFTs per sub-pixel. In FIG. 44 to FIG. 46, a wiring electrically connected to the lower electrode of the lower substrate is indicated by a two-dot chain line. A wiring electrically connected to one of the pair of comb-shaped electrodes on the lower substrate is indicated by a one-dot chain line. A wiring electrically connected to the other of the pair of the comb-shaped electrodes on the lower substrate is indicated by a closely spaced dotted line in these figures. A wiring electrically connected to the electrode in the upper substrate is indicated by a widely spaced dotted line in these figures. The lower electrode serves also as a Cs electrode, and is commonly connected to all the pixels. In FIG. 45 and FIG. 47, Cs indicates an auxiliary capacity formed by the overlapped comb-shaped electrodes and the Cs electrode, Clc1 indicates a liquid crystal capacity formed between the pair of comb-shaped electrodes, and Clc2 indicates a liquid crystal capacity formed between the electrodes of the pair of substrates. Also in FIG. 45, the capacitance of the dielectric layer formed between the electrodes of the pair of substrates is indicated by Coc.

In the Nth-line sub-pixels, the voltage applied to the counter electrode (iv) on the counter substrate side is 7.5 V during bright display, is 0 V during dark display (black display) after the bright display, and is 7.5 V in the initialization process. In the (N+1)st-line sub-pixels, the voltage applied to the counter electrode (iv) on the counter substrate side is 7.5 V during bright display, is 0 V during dark display (black display) after the bright display, and is 7.5 V in the initialization process. Here, the Nth line may be an even-numbered line and the (N+1)st line may be an odd-numbered line, or the Nth line may be an odd-numbered line and the (N+1)st line may be an even-numbered line.

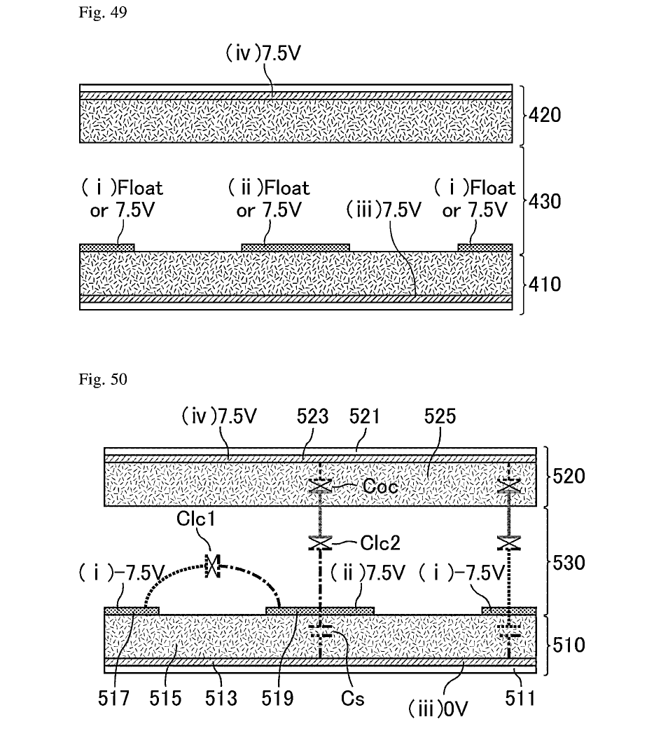

FIG. 47 is a schematic cross-sectional view illustrating the electrodes in the Nth line in the liquid crystal display panel of Embodiment 4 in the presence of a transverse electric field. FIG. 48 is a schematic cross-sectional view illustrating the electrodes in the Nth line in the liquid crystal display panel of Embodiment 4 in the presence of a vertical electric field. FIG. 49 is a schematic cross-sectional view illustrating the electrodes in the Nth line in the liquid crystal display panel of Embodiment 4 in the initialization process after generation of a vertical electric field.

In FIG. 47, the liquid crystals are driven by a transverse electric field between the pair of comb-shaped electrodes. In FIG. 48, both the comb-shaped electrodes and the lower electrode are at 7.5 V, and the counter electrode on the counter substrate side is at 0 V, so that a vertical electric field is generated. In FIG. 49, the alignment of the liquid crystals is refreshed (initialization process) with all the electrodes at 7.5 V (the pair of comb-shaped electrodes may float). The other reference numerals in the figures relating to Embodiment 4 are the same as those in the figures relating to Embodiment 1, except that a numeral “4” was added as the hundred's digit. The voltages applied to the respective electrodes are the same as those in Embodiment 2.

In Embodiment 4, the transmittance is increased (as illustrated in FIG. 45) by providing a dielectric layer 425 (also referred to as an overcoat layer or OC layer) on the counter substrate commonly connected to all the pixels. FIG. 45 shows the simulation results in the case that the thickness d of the liquid crystal layer is 3 μm, L/S is 2.6 μm/3 μm, the thickness of the OC layer is 1.5 μm, and the dielectric constant E of the OC layer is 3.7. Provision of the OC layer increased the transmittance from 8% (without the OC layer) to 20% (with the OC layer).

This is because, in comparison of with and without the OC layer using liquid crystal layers having the same thickness, the vertical components in the electric field distribution in the liquid crystal layer are weakened, and the transverse components are strengthened by a potential difference between the comb-shaped electrodes (during white display) in the liquid crystal layer with the OC layer.

The suitable range for the present embodiment is that, for example, the dielectric constant for dielectric layer is 1<s, and the thickness of the dielectric layer is 0<dOC<4 μm.

Increasing the thickness of the OC layer or decreasing the dielectric constant of the OC layer increases the transmittance in the presence of the transverse electric field, but weakens the effect of increasing the response speed in falling in the presence of a vertical electric field.

The OC layer can be a commonly used material (e.g. an organic insulating film such as acrylic resin with a thickness of about 1 to 3 μm and a dielectric constant of about 3 to 4, and an inorganic insulating film such as silicon nitride with a thickness of about 0.1 to 0.5 μm and a dielectric constant of about 6 to 7).

The same effect can be achieved by applying the configuration with an OC layer described in Embodiment 4 to the 1-TFT driving in Embodiment 3. Also, the same effect can be achieved even when the liquid crystals are negative liquid crystals.

The other configurations in Embodiment 4 are the same as those described above for Embodiment 1.

### Embodiment 5

### Same Configuration as that in Embodiment 2 Except that a Dielectric Layer is Provided on the Counter Electrode; Also Regarded as Another Alternative Embodiment of Embodiment 2. Also, Similarly to Embodiment 1, the Liquid Crystals are Driven by a Vertical Electric Field and a Transverse Electric Field Under the Second Driving Operation

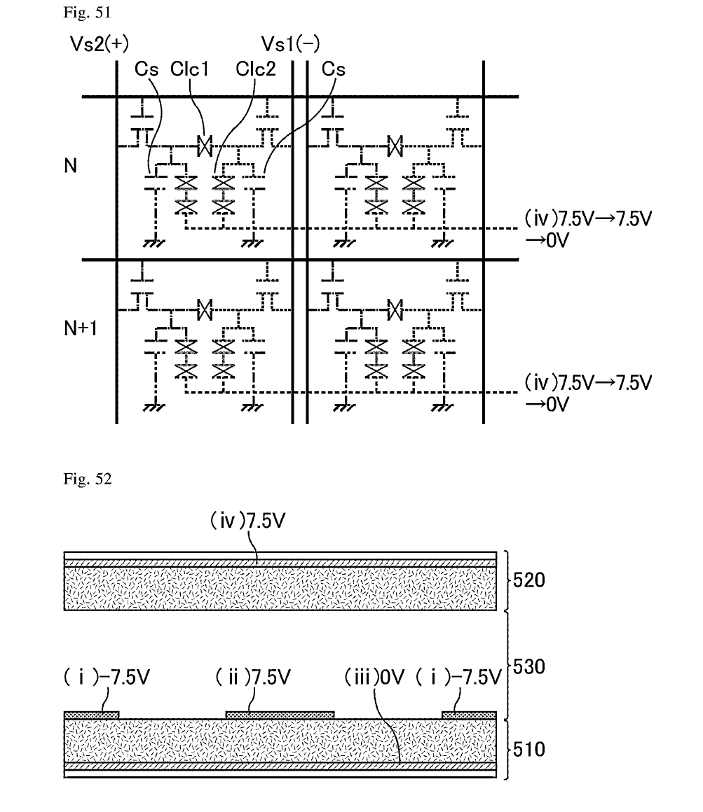

FIG. 50 is a schematic cross-sectional view of a liquid crystal display panel of Embodiment 5. FIG. 51 is a view of a sub-pixel equivalent circuit of the liquid crystal display panel of Embodiment 5. The driving method by the module in Embodiment 5 is driving two TFTs per sub-pixel. In FIG. 50 and FIG. 51, a wiring electrically connected to the lower electrode of the lower substrate is indicated by a two-dot chain line. A wiring electrically connected to one of the pair of comb-shaped electrodes on the lower substrate is indicated by a one-dot chain line. A wiring electrically connected to the other of the pair of the comb-shaped electrodes on the lower substrate is indicated by a closely spaced dotted line. A wiring electrically connected to the electrode in the upper substrate is indicated by a widely spaced dotted line. The lower electrode serves also as a Cs electrode, and is commonly connected to all the pixels. In FIG. 50 and FIG. 51, Cs indicates an auxiliary capacity formed by the overlapped comb-shaped electrodes and the Cs electrode, Clc1 indicates a liquid crystal capacity formed between the pair of comb-shaped electrodes, and Clc2 indicates a liquid crystal capacity formed between the electrodes of the pair of substrates. Also in FIG. 50, the capacitance of the dielectric layer formed between the electrodes of the pair of substrates is indicated by Coc.

In the Nth-line sub-pixels, the voltage applied to the counter electrode (iv) on the counter substrate side is 7.5 V during bright display, is 7.5 V during dark display (black display) after the bright display, and is 0 V in the initialization process. In the (N+1)st-line sub-pixels, the voltage applied to the counter electrode (iv) on the counter substrate side is 7.5 V during bright display, is 7.5 V during dark display (black display) after the bright display, and is 0 V in the initialization process. Here, the Nth line may be an even-numbered line and the (N₊1)st line may be an odd-numbered line, or the Nth line may be an odd-numbered line and the (N+1)st line may be an even-numbered line.

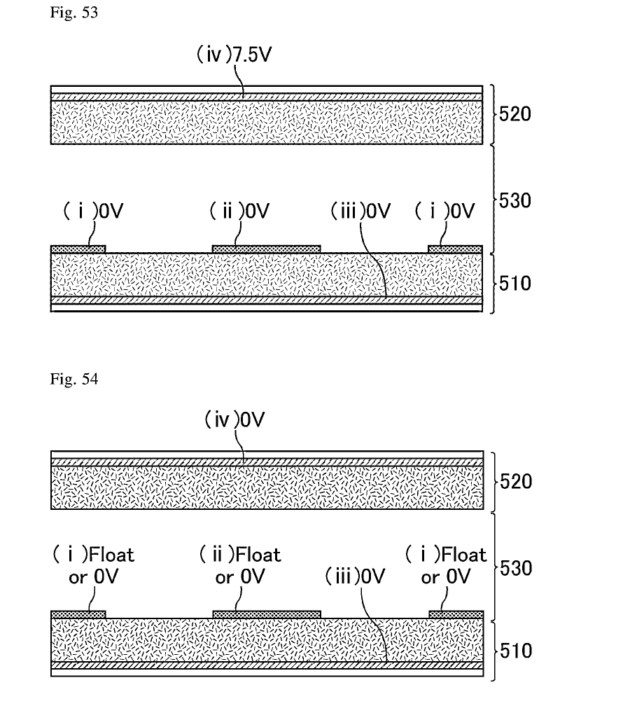

FIG. 52 is a schematic cross-sectional view illustrating the electrodes in the Nth line in the liquid crystal display panel of Embodiment 5 in the presence of a vertical electric field and a transverse electric field. FIG. 53 is a schematic cross-sectional view illustrating the electrodes in the Nth line in the liquid crystal display panel of Embodiment 5 in the presence of a vertical electric field. FIG. 54 is a schematic cross-sectional view illustrating the electrodes in the Nth line in the liquid crystal display panel of Embodiment 5 in the initialization process after generation of a vertical electric field.

In FIG. 52, the liquid crystals are driven by a transverse electric field between the pair of comb-shaped electrodes and a vertical electric field between the electrodes of the upper and lower substrates (between a counter electrode 523 and a set of a lower electrode 513 and a comb-shaped electrode 517). In FIG. 53, both the comb-shaped electrodes and the lower electrode are at 0 V, and the counter electrode on the counter substrate side is at 7.5 V, so that a vertical electric field is generated. In FIG. 54, the alignment of the liquid crystals is refreshed (initialization process) with all the electrodes at 0 V (the pair of comb-shaped electrodes may float). The other reference numerals in the figures relating to Embodiment 5 are the same as those in the figures relating to Embodiment 1, except that a numeral “5” was added as the hundred's digit.

In Embodiment 5, the transmittance is increased by providing a dielectric layer 525 (also referred to as an overcoat layer or OC layer) on the counter electrode commonly connected to all the pixels.

This is because, in comparison of with and without the OC layer using liquid crystal layers having the same thickness, the vertical components in the electric field distribution in the liquid crystal layer are weakened, and the transverse components are strengthened by a potential difference between the comb-shaped electrodes (during white display) in the liquid crystal layer with the OC layer.

The suitable range for the present embodiment is that, for example, the dielectric constant for dielectric layer is 1<∈, and the thickness of the dielectric layer is 0<dOC<4 μm.

Increasing the thickness of the OC layer or decreasing the dielectric constant of the OC layer increases the transmittance in the presence of the transverse electric field, but may weaken the effect of increasing the response speed in falling in the presence of a vertical electric field.

The OC layer can be a commonly used material (e.g. an organic insulating film such as acrylic resin with a thickness of about 1 to 3 μm and a dielectric constant of about 3 to 4, and an inorganic insulating film such as silicon nitride with a thickness of about 0.1 to 0.5 μm and a dielectric constant of about 6 to 7).

The other configurations in Embodiment 5 are the same as those described above for Embodiment 1.

### Other Embodiments

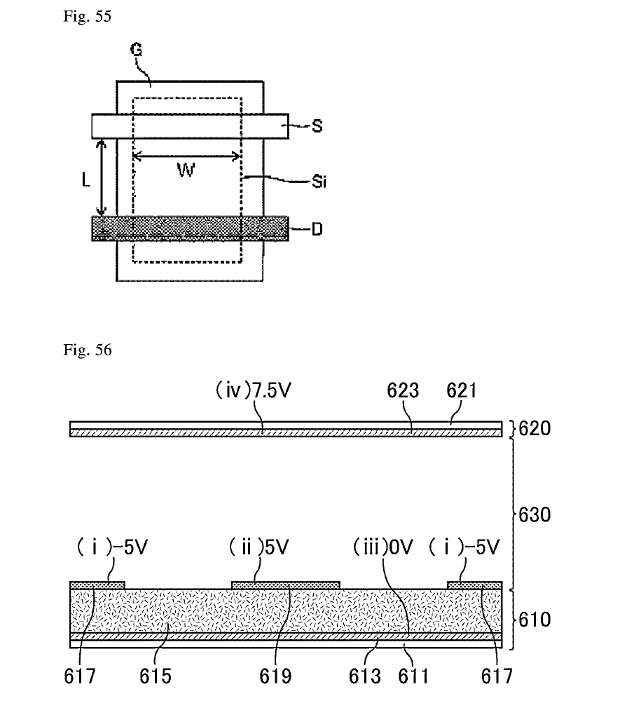

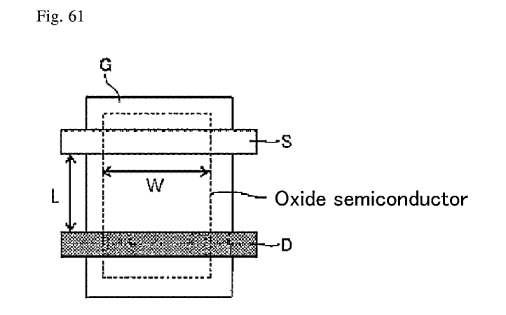

FIG. 55 and FIG. 61 are each a schematic plan view of one form of a thin-film transistor used for the pixel electrodes of a liquid crystal display panel of the present invention. The symbol S indicates a source electrode, the symbol D indicates a drain electrode, and the symbol G indicates a gate electrode.

The semiconductor in the thin-film transistor used for the pixel electrodes in the present invention is preferably an oxide semiconductor (e.g. indium gallium zinc complex oxide [IGZO]). Although FIG. 55 illustrates the case where a Si semiconductor layer is used, IGZO can be suitably used as a semiconductor layer in place of the Si semiconductor layer, which is illustrated in FIG. 61. The oxide semiconductor shows higher carrier mobility than amorphous silicon. Hence, the area of an oxide semiconductor transistor occupying a pixel can be made smaller than that of an amorphous silicon transistor. Specifically, the transistor can be miniaturized by 40 to 50%.

This miniaturization directly contributes to the aperture ratio, increasing the transmittance of light per pixel. Therefore, use of oxide semiconductor TFTs can more significantly achieve one effect of the present invention of increasing the transmittance.

Many of personal digital assistants (tablets, smartphones) which involve improvement in definition have about 300 pixels per inch (ppi), which is a pixel pitch of about 30 μm. The liquid crystal mode of the present invention described above and the increase in the aperture ratio caused by IGZO TFTs synergistically increase the transmittance.

For example, in the case of 35-μm pitch pixels, the aperture ratio (transmittance) can be increased by 5% as a result of reduction in the area of a TFT by use of IGZO as shown in the following Table 1. In the following Table 1, the symbol L (μm) indicates an example of the distance between the source electrode S and the drain electrode D illustrated in FIG. 55 and FIG. 61, and the symbol W (μm) indicates an example of the length of one side of the semiconductor layer illustrated in FIG. 55 and FIG. 61. The area (μm²) is the area of a TFT. The aperture ratio is the proportion of the area of the opening in one pixel.

TABLE 1

| 35-μm pitch | α-Si | IGZO |
|---|---|---|
| L (μm) | 4 | 4 |
| W (μm) | 9 | 5 |
| Area (μm²) | 235 | 100 |
| Aperture ratio (%) | 55 | 60 |

Furthermore, since the number of pixels has been increased along with the improvement in the definition, high-speed writing is required in high-speed driving. An oxide semiconductor having high carrier mobility can also be used advantageously in high-speed writing.

That is, in a high-definition liquid crystal panel with small pixels, the liquid crystal mode of the present invention and the oxide semiconductor TFTs can significantly improve the performance of the liquid crystal panel compared to a liquid crystal panel produced using the conventional amorphous TFTs.

The liquid crystal display device of the present embodiment achieves certain effects when used in combination with the above oxide semiconductor TFTs. Still, the liquid crystal display device can also be driven by known TFT elements such as amorphous silicon TFTs and polycrystalline silicon TFTs.

In the embodiments mentioned above, the driving operation not producing a potential difference between the first pair of electrodes and the second pair of electrodes (the operation is also referred to as the initialization process herein) was performed. This driving operation can sufficiently decrease the transmittance, which stays slightly high unless every electrode has the same electric potential, to the initial black state. In the present invention, the initialization process can be skipped.

In each of the above embodiments, the liquid crystal layer is sandwiched between the TFT substrate and the CF substrate and, usually, the TFT substrate serves as the lower substrate and the CF substrate serves as the upper substrate. In each of the embodiments, the TFT substrate (lower substrate) may include a color filter, and the counter substrate (upper substrate) may not include a color filter.

The liquid crystal display devices of the present embodiments may each be of the transmissive type, reflection type, or transflective type. Also, the liquid crystals had a positive anisotropy of dielectric constant in each of the embodiments, but may have a negative anisotropy of dielectric constant.

In each of the embodiments mentioned above, the liquid crystal display device basically aligns the liquid crystals in the vertical direction at a voltage lower than the threshold voltage. The liquid crystal display device, however, can appropriately utilize any other display mode if the effect of the present invention can be achieved.

### REFERENCE SIGNS LIST

10, 110, 210, 310, 410, 510, 610, 710: Lower substrate
11, 21, 111, 121, 211, 221, 311, 321, 411, 421, 511, 521,
611, 621, 711, 721: Glass substrate
13, 113, 213, 313, 413, 513, 613, 713: Lower electrode (counter electrode)
15, 115, 215, 315, 415, 515, 615, 715: Insulating layer
16: Pair of comb-shaped electrodes
17, 19, 117, 119, 217, 219, 317, 319, 417, 419, 517, 519,
617, 619: Comb-shaped electrode
20, 120, 220, 320, 420, 520, 620, 720: Counter substrate
23, 523, 723: Counter electrode
30, 130, 230, 330, 430, 530, 630, 730: Liquid crystal layer
31: Liquid crystals (liquid crystal molecules)
425, 525: Dielectric layer
717: Slit electrode

1. A liquid crystal display device comprising:
upper and lower substrates;
liquid crystals sandwiched between the upper and lower substrates; and
at least two pairs of electrodes disposed in the upper and lower substrates,
the at least two pairs of electrodes comprising a first pair of electrodes consisting of electrodes disposed in one of the upper and lower substrates, and a second pair of electrodes consisting of electrodes disposed in the respective upper and lower substrates,
the liquid crystal display device configured to drive the liquid crystals by generating a potential difference between each pair of the at least two pairs of electrodes, and to switch between a first driving operation of generating a potential difference only between the first pair of electrodes and a second driving operation of generating a potential difference between the first pair of electrodes and between the second pair of electrodes.

2. The liquid crystal display device according to claim 1, further comprising
a temperature sensor,
wherein the liquid crystal display device implements the first driving operation when the temperature of the liquid crystal display device measured by the temperature sensor is a certain switching temperature or higher, while the liquid crystal display device implements the second driving operation when the temperature of the liquid crystal display device is lower than the switching temperature.

3. The liquid crystal display device according to claim 2,
wherein the switching temperature is −10° C. or lower.

4. The liquid crystal display device according to claim 2,
wherein the switching temperature is −18° C. or higher.

5. The liquid crystal display device according to claim 1,
wherein the first pair of electrodes is a pair of comb-shaped electrodes.

6. The liquid crystal display device according to claim 1,
wherein the electrodes constituting the second pair each have a planar shape.

7. The liquid crystal display device according to any claim 1,
wherein one of the second pair of electrodes is separated from the first pair of electrodes by an insulating layer.

8. The liquid crystal display device according to claim 1,
wherein the liquid crystals have a positive anisotropy of dielectric constant.

9. A liquid crystal driving method for driving liquid crystals sandwiched between upper and lower substrates by generating a potential difference between each pair of at least two pairs of electrodes disposed in upper and lower substrates,
the at least two pairs of electrodes comprising a first pair of electrodes consisting of electrodes disposed in one of the upper and lower substrates, and a second pair of electrodes consisting of electrodes disposed in the respective upper and lower substrates,
the liquid crystal driving method comprising
switching between a first driving operation of generating a potential difference only between the first pair of electrodes and a second driving operation of generating a potential difference between the first pair of electrodes and between the second pair of electrodes.

10. The liquid crystal driving method according to claim 9,
wherein the liquid crystal driving method implements the first driving operation when the temperature of the liquid crystal display device measured by the temperature sensor is a certain switching temperature or higher, while the method implements the second driving operation when the temperature of the liquid crystal display device is lower than the switching temperature.

11. The liquid crystal driving method according to claim 10,
wherein the switching temperature is −10° C. or lower.

12. The liquid crystal driving method according to claim 10,
wherein the switching temperature is −18° C. or higher.

13. The liquid crystal driving method according to claim 9,
wherein the first pair of electrodes is a pair of comb-shaped electrodes.

14. The liquid crystal driving method according to claim 9,
wherein the electrodes constituting the second pair each have a planar shape.

15. The liquid crystal driving method according to claim 9,
wherein one of the second pair of electrodes is separated from the first pair of electrodes by an insulating layer.

16. The liquid crystal driving method according to claim 9,
wherein the liquid crystals have a positive anisotropy of dielectric constant.
